(19) United States
(12) Patent Application Publication
(10) Pub. No.: US 2018/0363092 A1
(43) Pub. Date: Dec. 20, 2018

(54) HIGH-STRENGTH ALLOYED HOT-DIPPED GALVANIZED STEEL SHEET HAVING EXCELLENT WORKABILITY AND DELAYED FRACTURE RESISTANCE, AND METHOD FOR PRODUCING SAME

(71) Applicant: Kabushiki Kaisha Kobe Seiko Sho (Kobe Steel, Ltd.), Kobe-shi (JP)

(72) Inventors: Muneaki IKEDA, Kakogawa-shi (JP); Michiharu NAKAYA, Kakogawa-shi (JP)

(73) Assignee: Kabushiki Kaisha Kobe Seiko Sho (Kobe Steel, Ltd.), Kobe-shi (JP)

(21) Appl. No.: 16/109,112

(22) Filed: Aug. 22, 2018

Related U.S. Application Data
(63) Continuation of application No. 15/127,942, filed on Sep. 21, 2016, now abandoned.

(30) Foreign Application Priority Data
Mar. 28, 2014 (JP) 2014-069351
Jan. 26, 2015 (JP) 2015-012751

(51) Int. Cl. C21D 9/46; C23C 2/02; B32B 15/01; B32B 15/04; B32B 15/18; C21D 8/02; C21D 9/48; C22C 38/28; C22C 38/32; C23C 30/00; C22C 38/38; C22C 38/16; C22C 38/14; C22C 38/12; C22C 38/08; C22C 38/06; C22C 38/04; C22C 38/02; C22C 38/00; C23C 2/40; C23C 2/28; C23C 2/06

(52) U.S. Cl. CPC C21D 9/46; Y10T 428/12757; Y10T 428/12799; Y10T 428/12951; Y10T 428/12958; Y10T 428/12972; B32B 15/01; B32B 15/012; B32B 15/04; B32B 15/18; C21D 8/0205; C21D 8/0226; C21D 8/0236; C21D 8/0263; C21D 9/48; C22C 38/28; C22C 38/32; C23C 30/00; C23C 30/005; Y10T 428/12792; C22C 38/38; C22C 38/16; C22C 38/14; C22C 38/12; C22C 38/08; C22C 38/06; C22C 38/04; C22C 38/02; C22C 38/002; C22C 38/001; B32B 15/013; C21D 2211/008; C22C 38/00; C23C 2/40; C23C 2/28; C23C 2/06; C23C 2/02

(57) ABSTRACT

Disclosed herein is a high-strength galvannealed steel sheet having a galvannealed layer on a surface of a base steel sheet and containing predetermined steel components. The steel sheet sequentially has, from the interface of the base steel sheet and the galvannealed layer, towards the base steel sheet: an internal oxide layer and containing at least one oxide selected from the group consisting of Si and Mn; a soft layer including the internal oxide layer, and satisfying a predetermined Vickers hardness; and a hard layer made up of a structure mainly composed of martensite. The average depth D of the soft layer is 20 μm or greater, and the average depth d of the internal oxide layer is 4 μm or greater and smaller than D. A coefficient of variation of KAM of the base steel sheet at the portion t/4 is 0.66 or less.

### TECHNICAL FIELD

The present invention relates to a high-strength galvannealed steel sheet having excellent formability in terms of both bendability and hole expandability, and excellent delayed fracture resistance, the steel sheet having a tensile strength of 1180 MPa or higher and a yield ratio YR of 73.0% or higher, and also relates to a method for producing the steel sheet.

### BACKGROUND ART

Galvannealed steel sheets that are widely used in fields such as automobiles, transport aircraft and the like, are required to have, in addition to high strength, also excellent formability in terms of bendability and hole expandability (stretch flangeability), and to exhibit moreover excellent delayed fracture resistance. Such galvannealed steel sheets are further required to have excellent impact absorption properties, i.e. a high yield ratio YR.

Adding a substantial amount of strengthening elements such as Si or Mn to steel is effective in order to secure high strength and formability. However, Si and Mn are readily oxidizable elements, and galvanizing wettability is significantly impaired by an oxide film, having Si oxides, Mn oxides and complex oxides of Si and Mn, that forms on the surface. This poor wettability gives rise to problems such as unplated portions or the like.

Various technologies have therefore been proposed with a view to enhancing the formability and so forth of galvannealed steel sheets that contain large amounts of Si and/or Mn.

For instance, Patent Literature 1 discloses a galvanized steel sheet excellent in bendability and corrosion resistance in worked portions, the steel sheet having a tensile strength of 590 MPa or higher. In further detail, Patent Literature 1 discloses the feature of significantly speeding up the growth of a decarburized layer with respect to the growth of an internal oxide layer that is formed from the interface of the steel sheet and a galvannealed layer, towards the latter, so as to enable suppression of bending cracks and damage to a galvannealed film that are caused by the internal oxide layer. Further, Patent Literature 1 discloses a surface-near structure in which the thickness of the internal oxide layer in a ferrite region formed by decarburization is controlled so as to be thin.

Further, Patent Literature 2 discloses a galvanized steel sheet excellent in fatigue durability, resistance to hydrogen embrittlement (synonymous with delayed fracture resistance) and bendability, the steel sheet having a tensile strength of 770 MPa or higher. In further detail, a steel sheet portion in Patent Literature 2 is configured to have a soft layer directly in contact with the interface with a galvannealed layer, and a soft layer in which ferrite is set to be the structure of highest area ratio. Further, Patent Literature 2 discloses a galvanized steel sheet in which a thickness D of the soft layer, and a depth d, from a galvannealed layer/base steel interface, of an oxide that contains one or more from among Si and Mn and that is present in a surface layer of a steel sheet, satisfy d/4≤D≤2d.

### CITATION LIST

### Patent Literature

Patent Literature 1: Japanese Unexamined Patent Publication No. 2011-231367

Patent Literature 2: Japanese Patent No. 4943558

### SUMMARY OF INVENTION

### Problem to be Solved by the Invention

As described above, various technologies have been proposed for enhancing the formability and so forth of galvannealed steel sheets that contain large amounts of Si and Mn. However, it would be desirable to provide a technology that combines all of various characteristics demanded from galvannealed steel sheets, namely high strength of 1180 MPa or higher coupled with formability in terms of bendability and hole expandability, as well as delayed fracture resistance, and wherein the steel sheet further has a high yield ratio YR and excellent impact absorption properties.

In the light of the above issues, it is an object of the present invention to provide a high-strength, of 1180 MPa or higher, galvannealed steel sheet having superior formability in terms of bendability and hole expandability, excellent in delayed fracture resistance, and excellent in impact absorption properties, and having a yield ratio YR of 73.0% or higher.

### Means for Solving the Problem

The gist of a high-strength galvannealed steel sheet according to the present invention which has a tensile strength of 1180 MPa or higher and a yield ratio YR of 73.0% or higher, and which allows attaining the above goal, is a galvannealed steel sheet having a galvannealed layer on a surface of a base steel sheet, wherein (1) the base steel sheet contains, in mass %, C: 0.05 to 0.25%, Si: 0.5 to 2.5%, Mn: 2.0 to 4%, P: more than 0% to 0.1% or less, S: more than 0% to 0.05% or less, Al: 0.01 to 0.1%, and N: more than 0% to 0.01% or less, the balance being iron and inevitable impurities; (2) the high-strength steel sheet sequentially has, from an interface of the base steel sheet and the galvannealed layer, towards the base steel sheet: an internal oxide layer containing at least one oxide selected from the group consisting of Si and Mn; a soft layer including the internal oxide layer and satisfying a Vickers hardness of 90% or less of a Vickers hardness at a portion t/4 of the base steel sheet, when t is a sheet thickness of the base steel sheet; and a hard layer made up of a structure mainly composed of martensite, the high-strength steel sheet satisfies: an average depth D of the soft layer being 20 μm or greater; and an average depth d of the internal oxide layer being 4 μm or greater and smaller than the D; and a coefficient of variation of KAM (Kernel Average Misorientation) of the base steel sheet at the portion t/4 being 0.66 or less.

In a preferred embodiment of the present invention, the base steel sheet further contains, in mass %, at least one element selected from the group consisting of Cr: more than 0% to 1% or less, Mo: more than 0% to 1% or less and B: more than 0% to 0.01% or less.

In a preferred embodiment of the present invention, the base steel sheet further contains, in mass %, at least one element selected from the group consisting of Ti: more than 0% to 0.2% or less, Nb: more than 0% to 0.2% or less and V: more than 0% to 0.2% or less.

In a preferred embodiment of the present invention, the base steel sheet further contains, in mass %, at least one element selected from the group consisting of Cu: more than 0% to 1% or less and Ni: more than 0% to 1% or less.

In a preferred embodiment of the present invention, the average depth d of the internal oxide layer and the average depth D of the soft layer satisfy the relationship D>2d.

In a preferred embodiment of the present invention, the structure of the hard layer is ferrite: 0 area % to 5 area % and bainite: 0 area % to 10 area %, with respect to the entire structure.

The gist of a production method (without temperature keeping) of the present invention that allows attaining the above goal is a method for producing any of the high-strength galvannealed steel sheets set forth above, the method having, in order: a hot rolling step of coiling, at a temperature of 600° C. or higher, a hot-rolled steel sheet satisfying steel components of the above-described base steel sheet; a step of pickling-cold rolling such that there remain 4 μm or more of the average depth d of the internal oxide layer; a step of oxidizing at an air ratio in a range of 0.9 to 1.4, in an oxidation zone; a step of soaking within a range Ac₃ point to (Ac₃ point+100° C.), in a reduction zone; a step of, after soaking, performing cooling at an average cooling rate of 5° C./sec or higher over a range down to 600° C.; a low-temperature keeping step of setting to 20 seconds or less the keeping time in a temperature region of 480° C. or lower until immersion in a galvanizing bath; a step of, after alloying, cooling at an average cooling rate of 10° C./sec or higher over a temperature region down to 300° C., and thereafter, cooling at an average cooling rate of 5° C./sec or lower over a temperature region from 300° C. to 150° C.

The gist of another production method (without temperature keeping) of the present invention that allows attaining the above goal is a method for producing any of the high-strength galvannealed steel sheets set forth above, the method having, in order: a hot rolling step of coiling, at a temperature of 600° C. or higher, a steel sheet satisfying steel components of the above-described base steel sheet; a step of pickling-cold rolling such that there remain 4 μm or more of the average depth d of the internal oxide layer; a step of oxidizing at an air ratio in a range of 0.9 to 1.4, in an oxidation zone; a step of soaking within a range Ac₃ point to (Ac₃ point+100° C.), in a reduction zone; a step of, after soaking, performing cooling at an average cooling rate of 5° C./sec or higher over a range down to 600° C.; a low-temperature keeping step of setting to 20 seconds or less the keeping time in a temperature region of 480° C. or lower until immersion in a galvanizing bath; a step of, after alloying, performing cooling at an average cooling rate of 10° C./sec or higher over a temperature region down to 300° C.; and a step of performing tempering in such a manner that Expression (1) is satisfied:

9000≤(A+273)×{ log(B/3600)+20)}≤13500 Expression (1)

where, A denotes tempering temperature (° C.), and B denotes tempering time (seconds).

The gist of yet another production method (with temperature keeping) of the present invention that allows attaining the above goal is a method for producing any of the high-strength galvannealed steel sheets set forth above, the method having, in order: a hot rolling step of coiling, at a temperature of 500° C. or higher, a hot-rolled steel sheet satisfying the steel components of the above-described base steel sheet; a step of keeping in a temperature region of 500° C. or higher for 80 minutes or more; a step of pickling-cold rolling such that there remain 4 μm or more of the average depth d of the internal oxide layer; a step of oxidizing at an air ratio in the range of 0.9 to 1.4, in an oxidation zone; a step of soaking within a range Ac₃ point to (Ac₃ point+100° C.), in a reduction zone; a step of, after soaking, performing cooling at an average cooling rate of 5° C./sec or higher over a range down to 600° C.; a low-temperature keeping step of setting to 20 seconds or less the keeping time in a temperature region of 480° C. or lower until immersion in a galvanizing bath; a step of, after alloying, cooling at an average cooling rate of 10° C./sec or higher over a temperature region down to 300° C., and thereafter, cooling at an average cooling rate of 5° C./sec or lower over a temperature region from 300° C. to 150° C.

The gist of yet another production method (with temperature keeping) of the present invention that allows attaining the above goal is a method for producing any of the high-strength galvannealed steel sheets set forth above, the method having, in order: a hot rolling step of coiling, at a temperature of 500° C. or higher, a steel sheet satisfying the steel components of the above-described base steel sheet; a step of keeping in a temperature region of 500° C. or higher for 80 minutes or more; a step of pickling-cold rolling such that there remain 4 μm or more of the average depth d of the internal oxide layer; a step of oxidizing at an air ratio in a range of 0.9 to 1.4, in an oxidation zone; a step of soaking within a range Ac₃ point to (Ac₃ point+100° C.), in a reduction zone; a step of, after soaking, performing cooling at an average cooling rate of 5° C./sec or higher over a range down to 600° C.; a low-temperature keeping step of setting to 20 seconds or less the keeping time in a temperature region of 480° C. or lower until immersion in a galvanizing bath; a step of, after alloying, performing cooling at an average cooling rate of 10° C./sec or higher over a temperature region down to 300° C.; and a step of performing tempering in such a manner that Expression (1) is satisfied:

9000≤(A+273)×{ log(B/3600)+20)}≤13500 Expression (1)

where, A denotes tempering temperature (° C.), and B denotes tempering time (seconds).

### Effects of the Invention

The high-strength galvannealed steel sheet of the present invention is made up of, sequentially from an interface of a galvannealed layer and a base steel sheet, towards the latter: an internal oxide layer having at least one oxide selected from the group consisting of Si and Mn; a soft layer including the region of the internal oxide layer; and a hard layer other than the soft layer, and being mainly composed of martensite. In particular, the internal oxide layer can be utilized as a hydrogen trap site by controlling the average depth d of the internal oxide layer to be 4 μm or greater. Accordingly, it becomes possible to suppress hydrogen embrittlement effectively, and to obtain a high-strength galvannealed steel sheet having a tensile strength of 1180 MPa or higher and being excellent in formability in terms of bendability and hole expandability, as well as excellent in delayed fracture resistance. Preferably, the relationship between the average depth d of the internal oxide layer and the average depth D of the soft layer that includes the region of the internal oxide layer is controlled properly; as a result, bendability and delayed fracture resistance in particular are further enhanced.

In the hard layer, the ratios of ferrite, bainite and fresh martensite are made as low as possible, and the structure is prescribed to be composed mainly of tempered martensite having high strain uniformity. As a result, the coefficient of variation of KAM is reduced to 0.66 or less. The yield ratio YR becomes accordingly 73.0% or higher, and impact absorption properties are improved.

### BRIEF DESCRIPTION OF DRAWINGS

FIG. 1 is a diagram for explaining schematically a layer configuration of a galvannealed steel sheet of the present invention, from an interface of a galvannealed layer and a base steel sheet towards the latter.

FIG. 2 is an explanatory diagram for measuring an average depth d of an internal oxide layer of the galvannealed steel sheet of the present invention.

FIG. 3 is a diagram for explaining measurement positions of Vickers hardness, used to establish an average depth D of a soft layer.

### DESCRIPTION OF EMBODIMENTS

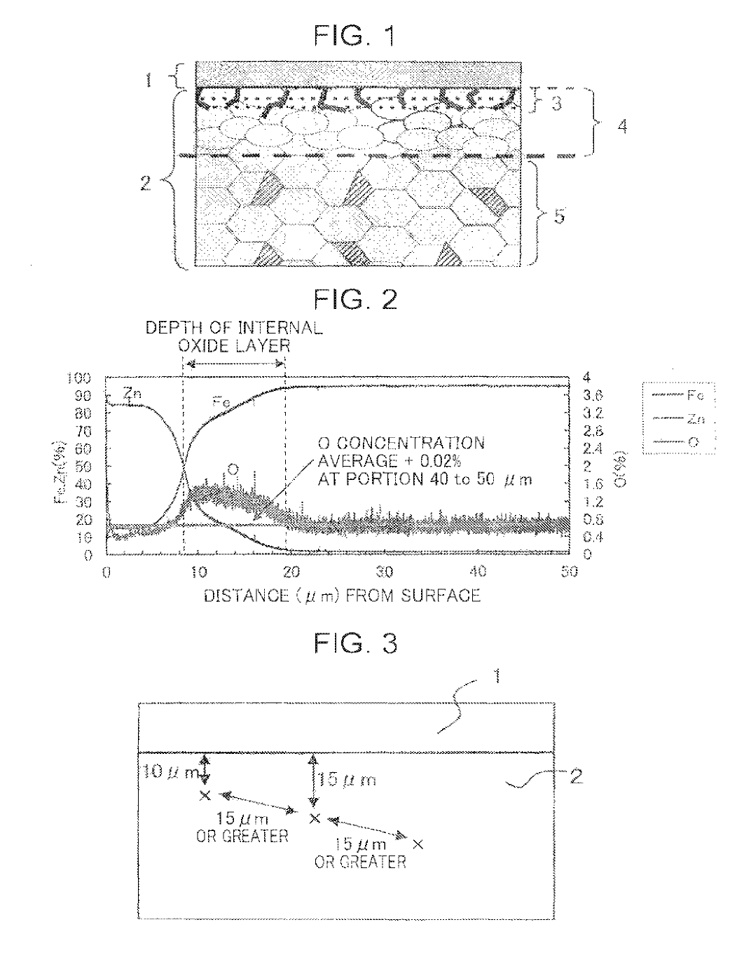

The inventors conducted exhaustive research focusing in particular on a layer configuration from the interface of a galvannealed layer and a base steel sheet towards the latter, with a view to providing a high-strength galvannealed steel sheet from a base steel sheet that contains a large amount of Si and Mn, the galvannealed steel sheet being of high strength, with a tensile strength of 1180 MPa or higher and a high yield ratio YR, of 73.0% or higher, and being excellent in all of impact absorption properties, formability and delayed fracture resistance. As a result, the inventors found that by (a) prescribing the layer configuration to be, from the interface of the galvannealed layer and the base steel sheet towards the latter: an internal oxide layer having at least one oxide selected from the group consisting of Si and Mn; a soft layer including the region of the internal oxide layer; and a hard layer other than the soft layer and composed mainly of martensite, as illustrated in the schematic diagram of FIG. 1 described below, (b) and by controlling the average depth d of the internal oxide layer to be 4 μm or greater, the internal oxide layer can function as a hydrogen trap site, and it becomes possible to suppress effectively hydrogen embrittlement, thereby achieving the intended purpose; further the inventors found that (c) a structure composed mainly of tempered martensite is achieved, and a yield ratio YR is significantly enhanced, when a coefficient of variation of KAM of the base steel sheet at a portion t/4 in the hard layer is reduced to 0.66 or less; (d) and that, preferably, bendability and delayed fracture resistance in particular are further enhanced if there is controlled properly the relationship between the average depth d of the internal oxide layer and the average depth D of the soft layer that includes a region of the internal oxide layer, and perfected the present invention on the basis of the above findings.

In the present specification, the term base steel sheet denotes a steel sheet before formation of a galvanized layer and a galvannealed layer, and is distinguished from the above galvannealed steel sheet.

In the present specification, the term high strength denotes a tensile strength of 1180 MPa or higher.

In the present specification, the term high impact absorption properties denotes a yield ratio YR of 73.0% or higher.

In the present specification, the feature of having excellent formability signifies exhibiting both excellent bendability and hole expandability. In further detail, a steel sheet satisfying the acceptance criteria in the examples described below upon measurement of the foregoing characteristics, in accordance with the methods described in the examples, will be referred to as a steel sheet having “excellent formability”.

The galvannealed steel sheet of the present invention, as described above, has a galvannealed layer (hereafter also referred to simply as plating layer) on the surface of the base steel sheet. The characterizing feature of the present invention is having the layer configuration (A) to (C) below, in this order, from the interface of the base steel sheet and the galvannealed layer towards the base steel sheet.

(A) Internal oxide layer includes at least one oxide selected from the group consisting of Si and Mn. An average depth d of the internal oxide layer is 4 μm or greater, and is smaller than an average depth D of a soft layer set forth in (B) below.
(B) Soft layer includes the above internal oxide layer, and satisfies having a Vickers hardness of 90% or less of the Vickers hardness at a portion t/4 of the base steel sheet, where t is the sheet thickness of the base steel sheet. The average depth D of the soft layer is 20 μm or greater.
(C) Hard layer has a structure mainly composed of martensite, and satisfies a coefficient of variation of KAM at the portion t/4 of the base steel sheet of 0.66 or less. Herein, the feature “mainly composed of” signifies that martensite exceeds 85 area %, in area ratio with respect to the entire structure, in a measurement of structure fraction by SEM observation after corrosion with a nital solution, described in the examples below.

The layer configuration (A) to (C), being the characterizing feature of the present invention, will be explained next in succession with reference to FIG. 1. As illustrated in FIG. 1, the layer configuration of the galvannealed steel sheet of the present invention, from the side of a base steel sheet 2, has a (B) soft layer 4, and a (C) hard layer 5 inward from the soft layer 4 in the base steel sheet 2, from the interface of the galvannealed layer 1 and the base steel sheet 2 towards the latter. The (B) soft layer 4 includes an (A) internal oxide layer 3. The soft layer 4 and the hard layer 5 are present contiguously.

(A) Internal Oxide Layer

As illustrated in FIG. 1, a portion directly in contact with the interface of the galvannealed layer and the base steel sheet has an internal oxide layer of an average depth d of 4 μm or greater. The term average depth denotes herein average depth from the interface; the detailed measurement method of the average depth will be explained further on with reference to FIG. 2 in the Example section below.

The internal oxide layer is made up of an oxide that includes at least one from among Si and Mn, and of a depletion layer of Si and Mn having little solid-solution Si or solid-solution Mn in the periphery as a result of the formation of oxides of Si and Mn.

The most distinctive feature of present invention involves controlling the average depth d of the internal oxide layer to a thickness of 4 μm or greater. By doing so, it becomes possible to exploit the internal oxide layer as a hydrogen trap site and to suppress hydrogen embrittlement, while enhancing bendability, hole expandability and delayed fracture resistance.

During annealing, i.e. during an oxidation-reduction step in a below-described continuous hot-dip galvanizing line, a complex oxide film of Si and Mn forms readily on the base steel sheet surface, and platability is hampered in a base steel sheet having a large amount of readily oxidizable elements such as Si and Mn, as in the present invention. Therefore, countermeasure methods are known that involve annealing (reduction annealing) in an atmosphere containing hydrogen, after generation of a Fe oxide film through oxidation of the base steel sheet surface in an oxidizing atmosphere. A further method involves controlling the atmosphere inside a furnace, to thereby fix readily oxidizable elements in the interior of a base steel sheet surface layer, in the form of oxides, and reduce the amount of readily oxidizable elements being in solid solution in the base steel sheet surface layer, to prevent as a result formation of an oxide film of readily oxidizable elements on the base steel sheet surface.

However, results of studies by the inventors have revealed that in oxidation-reduction methods generally resorted to in order to plate a base steel sheet having a large amount of Si and Mn, hydrogen in the hydrogen atmosphere during reduction intrudes into the base steel sheet, giving rise to an impairment of bendability and hole expandability due to hydrogen embrittlement. It has also been found that using at least one oxide selected from the group consisting of Si and Mn is effective in order to improve such impairment. In further detail, it has been found that the above oxides prevent intrusion of hydrogen into the base steel sheet during reduction, and are thus useful as hydrogen trap sites that allow improving bendability, hole expandability and delayed fracture resistance. It has been further found that, in order to effectively elicit the above effect, it is essential to form the internal oxide layer thicker such that the average depth d of the internal oxide layer including the oxides is 4 μm or greater.

In the present invention, the upper limit of the average depth d of the internal oxide layer is at least lower than the average depth D of the (B) soft layer below. Preferably, the upper limit of d is 30 μm or smaller. That is because although prolonged keeping in a high-temperature region after hot-rolled coiling is required in order to thicken the internal oxide layer, the upper limit takes on roughly the above preferred value, given productivity and equipment constraints. The above d is more preferably 18 μm or smaller, and yet more preferably 16 μm or smaller. The above d is preferably 6 μm or greater, more preferably 8 μm or greater and yet more preferably greater than 10 μm.

In the present invention, preferably, the average depth d of the internal oxide layer is controlled in such a way so as to satisfy a relational expression D>2d in a relationship with the average depth D of the (B) soft layer described below. Bendability and delayed fracture resistance (in particular, bendability) are further enhanced as a result. In this regard, Patent Literature 2 described above discloses a galvanized steel sheet that satisfies d/4≤D≤2d for a presence depth d of an oxide and a thickness D of a soft layer that substantially correspond to the average depth d of the internal oxide layer and the average depth D of the soft layer described in the present invention. However, control directionality is completely different from that of the relational expression (D>2d) prescribed in the present invention. Patent Literature 2 discloses the feature of controlling the range of the presence depth d of an oxide while basically satisfying the relationship d/4≤D≤2d described above, but does not involve at all the basic idea of controlling the average depth d to a thickness of 4 μm or greater, as in the present invention. Needless to say, Patent Literature 2 does not disclose the effect of the present invention that is elicited as a result, i.e. effective functioning as hydrogen trap site and affording enhanced bendability, hole expandability and delayed fracture resistance.

In order to control the average depth d of the internal oxide layer to be 4 μm or greater in the present invention, it is necessary to control to 4 μm or more the average depth of the internal oxide layer in the cold-rolled steel sheet before passing through a continuous galvanizing line. The details are described below in the section relating to a production method. Specifically, the internal oxide layer after pickling and cold rolling goes on to become an internal oxide layer in a galvannealed steel sheet that is obtained eventually after passage through a galvannealing line, as in the examples described below.

(B) Soft Layer

As illustrated in FIG. 1, in the present invention the soft layer is a layer including a region of the above (A) internal oxide layer, and satisfying having a Vickers hardness of 90% or less of the Vickers hardness at a portion t/4 of the base steel sheet. The detailed measurement method of the Vickers hardness is explained in the below-described Example section.

The soft layer has a soft structure of lower Vickers hardness than that of the hard layer (C) described below, exhibits excellent deformability, and accordingly, affords in particular enhanced bendability. That is, although the surface layer portion of the base steel sheet is an origin of cracks during bending work, bendability is particularly improved through formation of a predetermined soft layer on the base steel sheet surface layer, as in the present invention. Moreover, forming the soft layer allows preventing the oxide inside (A) from becoming an origin of cracks during bending work, and to enjoy only the benefits of the oxide acting as a hydrogen trap site, as described above. As a result, not only bendability but also delayed fracture resistance is further enhanced.

The average depth D of the soft layer is set to be 20 μm or greater in order to effectively elicit the effect derived from forming such a soft layer. The above D is preferably 22 μm or greater, and more preferably 24 μm or greater. When the average depth D of the soft layer is excessive, on the other hand, the strength of the galvannealed steel sheet itself drops, and accordingly, it is preferable to set the upper limit of the average depth D to be 100 μm or smaller. The above D is more preferably 60 μm or smaller.

(C) Hard Layer

In the present invention, as illustrated in FIG. 1, the hard layer is formed on the base steel sheet 2 side of the (B) soft layer 4, is made up of a structure mainly composed of martensite, and has a coefficient of variation of KAM at the portion t/4 of the base steel sheet of 0.66 or less. The above martensite is the structure observed under SEM (Scanning Electron Microscope) after nital corrosion, described in the examples described below.

Bendability and hole expandability are enhanced through formation of the hard layer. That is, bending cracks and/or cracks that arise during hole expansion occur generally as a result of stress concentration at the interface of a soft phase, for instance ferrite, and a hard phase, for instance martensite. Hence, the hardness difference between the soft phase and the hard phase must be reduced in order to suppress the above cracks. In the present invention, therefore, the structure inside the base steel sheet is prescribed to yield a hard layer mainly composed of martensite, by curtailing the ratio of soft ferrite to be preferably 5 area % at the largest. In order to increase YR, it is necessary to curtail the ratio of ferrite and/or bainite that cause YR to drop, and to prescribe a structure composed mainly of martensite.

Herein, the feature “mainly composed of” signifies that martensite exceeds 85 area %, in area ratio with respect to the entire structure, in a measurement of structure fraction by SEM observation after nital corrosion, described in the examples below. Examples of structures other than martensite include, for instance, ferrite and bainite. The greater the area ratio of martensite, which is the main phase, the better; preferably the area ratio is 90 area % or higher, more preferably 93 area % or higher and most preferably 100 area %. The smaller the area ratio of ferrite and bainite other than martensite the better. The area ratio of ferrite is preferably 5 area % or lower, more preferably 2 area % or lower and most preferably 0 area %. The area ratio of bainite is preferably 10 area % or lower, more preferably 6 area % or lower and most preferably 0 area %.

Besides the above-described martensite, ferrite and bainite, the hard layer may include structures, for instance residual austenite, perlite or the like that may be unavoidably mixed in during production, in amounts that do not impair the effect of the present invention. Such a structure is 5 area % at the greatest, and the smaller the better. Such structures are notated in the tables below as “other”.

It has been found that, in order to obtain a desired high YR, it is also necessary to control the structure of martensite, being the main structure, in addition to controlling ferrite and bainite to the above-described area ratio. Specifically, the inventors studied the influence of structure on steel sheet characteristics, and found that YR is affected by variability in relative strain in the structure. Further, it was found that YR can be enhanced by curtailing variability in relative strain within the hard phase.

In the present specification, martensite is made up of fresh martensite and tempered martensite. Tempered martensite exhibits smaller variability in relative strain within the structure, as compared with fresh martensite, and accordingly, it is estimated that YR is enhanced by increasing the ratio of tempered martensite. However, the tempered martensite that is necessary in order to secure high YR and fresh martensite that causes a decrease in YR cannot be clearly distinguished in normal microscope observation, for instance SEM observation, and both are observed as martensite. Therefore, the definition of the structure of the hard layer in the present invention involves prescribing the requirement “coefficient of variation of KAM 0.66”, in addition to prescribing that the structure be mainly composed of martensite in a SEM observation.

The term KAM denotes herein a value calculated on the basis of electron backscatter diffraction (EBSD) as explained in the Example section described below, the value being an average value of crystal rotation amount (crystal orientation difference) between a target measurement point and a measurement point surrounding the target measurement point. The larger the value of KAM, which is a parameter correlated to plastic strain, the greater is the presence of strain denoted thereby. The coefficient of variation of KAM as used in the present invention is an index normalized by a ratio of standard deviation and mean (standard deviation/mean); the smaller the value of the coefficient of variation of KAM, the smaller is the relative variability of strain denoted thereby.

The inventors studied the influence of structure on the mechanical characteristics of steel sheets, and found that YR can be increased to 73.0% or higher through suppression of variability in relative strain by reducing the coefficient of variation of KAM down to 0.66 or less. It is estimated that a structure composed mainly of tempered martensite is achieved by prescribing the coefficient of variation of KAM to be 0.66 or less. It has been likewise found that the coefficient of variation of KAM increases beyond 0.66 when the ferrite and/or bainite structure is substantial; this constitutes accordingly a further reason for prescribing the above requirement in the present invention.

The layer configuration from the interface of the galvannealed layer and the base steel sheet, towards the latter, and which is the most significant characterizing feature of the present invention, has been thus explained above.

The steel components that are used in the present invention will be explained next.

The galvannealed steel sheet of the present invention contains C: 0.05 to 0.25%, Si: 0.5 to 2.5%, Mn: 2.0 to 4%, P: more than 0% to 0.1% or less, S: more than 0% to 0.05% or less, Al: 0.01 to 0.1% and N: more than 0% to 0.01% or less, the balance being iron and inevitable impurities.

C: 0.05 to 0.25%

Herein, C has the effect of enhancing hardenability and of hardening martensite, by virtue of which C is an important element in terms of increasing steel strength. In order to effectively bring out that effect, the lower limit of the amount of C is set to 0.05% or higher. The preferred lower limit of the amount of C is 0.08% or higher, more preferably 0.10% or higher. When C is added in an excessive amount, however, the hardness difference between the soft phase and the hard phase increases, formability and delayed fracture resistance decrease, the KAM coefficient of variation becomes greater, and YR decreases. The upper limit of the amount of C is set to 0.25% or lower. The preferred upper limit of C is set to 0.2% or lower, more preferably 0.18% or lower.

Si: 0.5 to 2.5%

Herein, Si is an effective element in terms of increasing the strength of steel and enhancing formability, through solid-solution strengthening. Further, Si has the effect of generating an internal oxide layer and suppressing hydrogen embrittlement. In order to effectively bring out that effect, the lower limit of the amount of Si is set to be 0.5% or higher. The preferred lower limit of the amount of Si is 0.75% or higher, more preferably 1% or higher. However, Si is a ferrite-generating element, and when added in an excessive amount, generation of ferrite cannot be suppressed, the hardness difference between the soft phase and the hard phase increases, and formability and YR decrease. Further, platability as well is impaired, and hence the upper limit of the amount of Si is set to 2.5% or lower. The preferred upper limit of Si is set to 2% or lower, more preferably 1.8% or lower.

Mn: 2.0 to 4%

Herein, Mn is a hardenability-enhancing element that suppresses ferrite and bainite and contributes to increasing strength and achieving a higher YR through generation of martensite. In order to effectively bring out that effect, the lower limit of the amount of Mn is set to be 2.0% or higher. The preferred lower limit of the amount of Mn is 2.3% or higher, more preferably 2.5% or higher. When Mn is added in an excessive amount, however, platability decreases, and segregation becomes marked. A further concern is the resulting promotion in P grain size segregation. Accordingly, the upper limit of the amount of Mn is set to be 4% or lower. The preferred upper limit of the amount of Mn is 3.5% or lower.

P: More than 0% to 0.1% or Less

As a solid-solution strengthening element, P is a useful element for strengthening steel. In order to effectively bring out that effect, the lower limit of the amount of P is set to exceed 0%. If the addition amount is excessive, however, not only formability but weldability and toughness might become impaired, and accordingly, the upper limit of the addition amount is set to 0.1% or lower. The smaller the amount of P the better, preferably of 0.03% or lower, more preferably 0.015% or lower.

S: More than 0% to 0.05% or Less

Herein, S forms sulfides such as MnS, giving rise to origins of cracks and the concern of impaired formability.

Accordingly, the upper limit of the amount of S is set to 0.05% or lower. The smaller the amount of S the better, preferably of 0.01% or lower, more preferably 0.008% or lower.

Al: 0.01 to 0.1%

Herein, Al acts as a deoxidizing agent. By bonding with N to form AlN thereby, Al has the effect of enhancing formability and delayed fracture resistance by making the grain size of austenite finer. In order to effectively bring out that effect, the lower limit of the amount of Al is set to be 0.01% or higher. The preferred lower limit of the amount of Al is 0.02% or higher, more preferably 0.03% or higher. When Al is added in an excessive amount, however, inclusions of alumina and the like increase, and both formability and toughness are impaired as a result. Accordingly, the upper limit of the amount of Al is set to 0.1% or lower. The preferred upper limit of Al is set to 0.08% or lower, more preferably 0.05% or lower.

N: More than 0% to 0.01% or Less

Herein, N is an element of unavoidable presence which, if excessive, detracts from formability. Further, BN precipitates are formed when B (boron) is added to the steel, and the hardenability-enhancing effect of B is thus hampered. Accordingly, the content of N should be reduced as much as possible. Therefore, the upper limit of the amount of N is set to be 0.01% or lower. The preferred upper limit of the amount of N is set to 0.008% or lower, more preferably 0.005% or lower.

The galvannealed steel sheet of the present invention contains the above components, the balance being iron and inevitable impurities.

The optional elements below can be incorporated in the present invention.

At least one element selected from the group consisting of Cr: more than 0% to 1% or less, Mo: more than 0% to 1% or less and B: more than 0% to 0.01% or less

These elements are effective elements in terms of enhancing the strength of the steel sheet. The foregoing elements can be incorporated singly or in combinations of two or more elements.

In further detail, Cr contributes to enhancing hardenability and increasing strength. Further, Cr suppresses generation and growth of cementite, and contributes to improving bendability. In order to effectively bring out that effect, the lower limit of the amount of Cr is set to be 0.01% or higher. However, platability decreases when Cr is added in an excessive amount. Further, Cr carbides are generated excessively, and formability is impaired. Accordingly, the preferred upper limit of the amount of Cr is set to 1% or lower, more preferably to 0.7% or lower and yet more preferably to 0.4% or lower.

Herein, Mo is effective in increasing strength, and accordingly, the preferred lower limit of the amount of Mo is set to 0.01% or higher. Even when added in excess, the effect of Mo levels off while giving rise to an increase in costs. Accordingly, the preferred upper limit of the amount of Mo is set to 1% or lower, more preferably to 0.5% or lower and yet more preferably to 0.3% or lower.

As in the case of manganese (Mn), B is a hardenability-enhancing element that suppresses ferrite and bainite, and that generates martensite, contributing thus to enhancing strength. In order to effectively bring out that effect, the lower limit of the amount of B is set to be 0.0002% or higher, more preferably to 0.0010% or higher. However, an excessive amount of B results in poorer hot formability; accordingly, the preferred upper limit of the amount of B is set to 0.01% or lower, more preferably to 0.0070% or lower and yet more preferably to 0.0050% or lower.

At least one element selected from the group consisting of Ti: more than 0% to 0.2% or less, Nb: more than 0% to 0.2% or less and V: more than 0% to 0.2% or less

These elements are effective elements in enhancing formability and delayed fracture resistance by making the structure finer. The foregoing elements can be added singly or in combinations of two or more elements.

In order to effectively bring out the effect of the elements, the lower limits of Ti, Nb and V are set to 0.01% or higher. However, ferrite is generated and formability impaired when the content of these elements is excessive; accordingly, the preferred upper limit of the amount of these elements is set to 0.2% or lower, more preferably to 0.15% or lower and yet more preferably to 0.10% or lower, for all the elements.

At least one element selected from the group consisting of Cu: more than 0% to 1% or less and Ni: more than 0% to 1% or less

Herein, Cu and Ni are effective element in terms of increasing strength. The foregoing elements may be added singly or may be used concomitantly.

In order to effectively bring out the effect of the elements, the lower limits of Cu and Ni are set to 0.01% or higher. However, as hot formability decreases when the content of these elements is excessive, the preferred upper limit of the amount of these elements is set to 1% or lower, more preferably to 0.8% or lower and yet more preferably to 0.5% or lower, for all the elements.

The steel components of the present invention have been explained above.

A method for producing the galvannealed steel sheet of the present invention will be explained next. The production method of the present invention includes a first method that involves pickling without temperature keeping after hot-rolled coiling, and a second method that involves pickling after temperature keeping following hot-rolled coiling. The lower limit of the hot-rolled coiling temperature varies between the first method (without temperature keeping) and the second method (with temperature keeping), depending on the presence or absence of temperature keeping. However, other steps are identical in the methods. The relevant details are as follows.

[First Production Method (without Temperature Keeping)]

The first production method according to the present invention can be divided roughly into: a hot rolling step; a pickling and cold rolling step; and an oxidation step, a reduction step and a galvannealing step in a continuous galvanizing line (CGL (Continuous Galvanizing Line)). A characterizing feature of the present invention is to include the following steps, in order: a hot rolling step of coiling a steel sheet that satisfies the above steel components at a temperature of 600° C. or higher, to obtain as a result a hot-rolled steel sheet having an internal oxide layer formed therein; a step of pickling-cold rolling such that there remain 4 μm or more of the average depth d of the internal oxide layer; a step of oxidizing at an air ratio in the range of 0.9 to 1.4, in an oxidation zone; a step of soaking within a range Ac₃ point to (Ac₃ point+100° C.), in a reduction zone; a step of, after soaking, performing cooling at an average cooling rate of 5° C./sec or higher over a range down to 600° C.; a low-temperature keeping step of setting to 20 seconds or less the keeping time in a temperature region of 480° C. or lower until immersion in a galvanizing bath; and a step for, after alloying, obtaining a structure composed mainly of martensite. In the present invention, the step for obtaining a structure composed mainly of tempered martensite in which the coefficient of variation of KAM is 0.66 or less, after alloying, involves performing (1A) or (1B) below.

(1A) step of, after alloying, cooling at an average cooling rate of 10° C./sec or higher over a temperature region down to 300° C., and thereafter, cooling at an average cooling rate of 5° C./sec or lower over a temperature region from 300° C. to 150° C.; or
(1B) a step of, after alloying, cooling at an average cooling rate of 10° C./sec or higher over a temperature region down to 300° C., and a step of performing tempering in such a manner that Expression (1) is satisfied:

9000≤(A+273)×{ log(B/3600)+20)}≤13500 Expression (1)

In Expression (1), A denotes tempering temperature (° C.), and B denotes tempering time (seconds).

The steps will be explained next in succession.

Firstly, there is prepared a hot-rolled steel sheet that satisfies the above steel components. Hot rolling may be carried out according to an ordinary method. Preferably, for instance, the heating temperature is set to lie in the range of about 1150 to 1300° C. in order to prevent coarsening of austenite grains. Preferably, the finish rolling temperature is controlled to lie roughly in the range of 850 to 950° C.

In the present invention, it is important to control the coiling temperature after hot rolling to be 600° C. or higher. As a result, an internal oxide layer is formed on the base steel sheet surface and a soft layer as well is formed through decarburization; hence, it becomes possible to obtain a desired internal oxide layer and a desired soft layer in the steel sheet after galvannealing. The internal oxide layer and the soft layer are not sufficiently generated in a case where the coiling temperature is lower than 600° C. Further, strength in the hot-rolled steel sheet is lowered, and cold ductility drops as well. A preferred coiling temperature is herein 620° C. or higher, and more preferably 640° C. or higher. When the coiling temperature is excessively high, however, the growth of black skin scale is excessive, and the latter cannot be dissolved by pickling; accordingly, the upper limit is preferably set to 750° C. or lower.

Next, the hot-rolled steel sheet thus obtained is subjected to pickling-cold rolling in such a manner that there remain 4 μm or more of the average depth d of the internal oxide layer. As a result, there remains not only the internal oxide layer but also the soft layer, and in consequence, also the desired soft layer can be readily generated after galvannealing. Controlling the thickness of an internal oxide layer through control of pickling condition is a known feature. Specifically, there may be properly controlled, among others, the temperature and time of pickling in such a manner that the desired thickness of the internal oxide layer can be secured in accordance with, for instance, the type, concentration and so forth of the pickling solution that is used.

For instance, a mineral acid such as hydrochloric acid, sulfuric acid, nitric acid or the like can be used as the pickling solution.

There is generally a trend whereby a higher concentration and/or temperature of the pickling solution, and longer pickling time, translate into a thinner internal oxide layer through dissolution. Conversely, removal of black skin scale layer through pickling becomes insufficient when the concentration or temperature of the pickling solution is low and the pickling time is short. Accordingly, it is recommended to control the concentration so as to lie in the range of about 3 to 20%, the temperature in the range of 60 to 90° C., and the time in the range of about 35 to 200 seconds, when using for instance hydrochloric acid.

The number of pickling baths is not particularly limited, and a plurality of pickling baths may be used herein. For instance a pickling suppressant, i.e. inhibitor such as an amine or a pickling promoter or the like may be added to the pickling solution.

After pickling, cold rolling is performed in such a manner that there remain 4 μm or more of the average depth d of the internal oxide layer. Preferably, the cold rolling condition is controlled in such a manner that a cold rolling ratio lies in the range of about 20 to 70%.

Oxidation and reduction are performed next.

In detailed terms, firstly oxidation is carried out at an air ratio in the range of 0.9 to 1.4, in an oxidation zone. The term air ratio denotes herein a ratio of the amount of air actually supplied with respect to the amount of air stoichiometrically necessary in order to completely burn off combustion gas that is supplied. An air ratio higher than 1 entails an excess of oxygen, while an air ratio lower than 1 entails a shortage of oxygen. In the examples described below, CO gas is used as the combustion gas.

Decarburization is promoted through oxidation in an atmosphere the air ratio whereof lies in the above range; the desired soft layer is formed and bendability is improved as a result. Further, it becomes possible to generate a Fe oxide film on the surface and to inhibit generation of a complex oxide film or the like that is detrimental to platability. When the air ratio is lower than 0.9, decarburization is insufficient, a sufficient soft layer is not formed, and bendability is impaired as a result. Further, generation of the Fe oxide film becomes insufficient, generation of for instance the above complex oxide film cannot be suppressed, and platability is impaired. The air ratio has to be controlled to 0.9 or higher, and is preferably controlled to 1.0 or higher. When, on the other hand, the air ratio is high, in excess of 1.4, the Fe oxide film is generated excessively, and cannot be sufficiently reduced in a subsequent reduction furnace, which hinders platability. The air ratio has to be controlled to 1.4 or lower, and is preferably controlled to 1.2 or lower.

In the oxidation zone, it is particularly important to control the air ratio. Ordinarily used methods can be resorted to herein as regards other conditions. For instance, the preferred lower limit of the oxidation temperature is 500° C. or higher, more preferably 750° C. or higher. The upper limit of the oxidation temperature is 900° C. or lower, more preferably 850° C. or lower.

Next, the oxide film is reduced in a hydrogen atmosphere, in a reduction zone. In order to obtain the desired hard layer through suppression of ferrite in the present invention, it is necessary to perform heating in an austenite single-phase region; a soaking treatment is performed thus in the range Ac₃ point to (Ac₃ point+100° C.). Ferrite becomes excessive when the soaking temperature is lower than the Ac₃ point, while austenite becomes coarser, and formability poorer, when the soaking temperature exceeds Ac₃ point+100° C. The preferred soaking temperature lies in the range of Ac₃ point+15° C. to Ac₃ point+85° C.

In the present invention the Ac₃ point is calculated on the basis of Expression (i) below. The brackets [ ] in the expression denote content (mass %) of the elements. The expression is disclosed in “The Physical Metallurgy of Steels” (William C. Leslie, Published by Maruzen, page 273).

Ac₃(° C.)=910−203×[C]^{1/2}−15.2×[Ni]+44.7×[Si]+104×[V]+31.5×[Mo]+13.1×[W]−{30×[Mn]+11×[Cr]+20×[Cu]−700×[P]−400×[Al]−120×[As]−400×[Ti]} (i)

In a reduction furnace, it is particularly important to control the soaking temperature. Ordinarily used methods can be resorted to herein as regards other conditions. Preferably, for instance, the atmosphere of the reduction zone includes hydrogen and nitrogen, and the hydrogen concentration is controlled to lie in the range of about 5 to 25 vol %. The dew point is controlled to lie in the range of −30 to −60° C.

When the keeping time during the soaking treatment is short, reduction is insufficient and platability is hampered. Accordingly, the lower limit of the keeping time is preferably 10 seconds or longer, more preferably 30 seconds or longer. On the other hand, a long keeping time detracts from productivity. Accordingly, the upper limit of the keeping time is preferably 100 seconds or shorter, more preferably 80 seconds or shorter.

Cooling is performed next. The average cooling rate during cooling is controlled to 5° C./sec or higher over a temperature region from the soaking temperature down to about 600° C., in such a manner that generation of ferrite can be suppressed. Preferably, the average cooling rate is 8° C./sec or higher. The upper limit of the average cooling rate is not particularly limited, but is preferably controlled to about 100° C./sec or lower, for instance in terms of ease of control of the base steel sheet temperature and equipment cost. A more preferred average cooling rate is 50° C./sec or lower, and yet more preferably 30° C./sec or lower.

Cooling over a temperature region down to about 600° C., as described above, is followed by galvanizing through immersion into a known galvanizing bath. In doing so, it is necessary to control to 20 seconds or less the keeping time at the temperature region of 480° C. or lower before galvanizing. When the keeping time in the low-temperature keeping step exceeds 20 seconds, bainite forms in a large amount, and the coefficient of variation of KAM exceeds the upper limit of 0.66. The keeping time is preferably 16 seconds or shorter, more preferably 12 seconds or shorter. Preferably, the lower limit of the keeping time is about 5 seconds or longer, for instance in terms of sheet temperature constraints during immersion in the galvanizing bath.

Thereafter, galvanizing is carried out in accordance with an ordinary method, and an alloying process is carried out subsequently. The galvanizing method is not particularly limited, and for instance the preferred lower limit of the galvanizing bath temperature is 400° C. or higher, more preferably 440° C. or higher. Moreover, preferred upper limit of the galvanizing bath temperature is 500° C. or lower, more preferably 470° C. or lower. The composition of the galvanizing bath is not particularly limited, and a known galvanizing bath may be used herein.

The conditions of the alloying process as well are not particularly limited. Preferably, for instance, galvanizing is carried out under the above conditions, and thereafter the temperature is kept in the range of about 500 to 600° C., in particular in the range of about 530 to 580° C., for about 5 to 30 seconds, in particular for about 10 to 25 seconds. Below the above ranges alloying is insufficient, whereas above the above ranges alloying progresses excessively, and galvannealing peeling may occur during press forming of the galvannealed steel sheet. Moreover, ferrite is generated readily in such a case. The alloying process may be carried out using for instance a heating furnace, open fire or an infrared heating furnace. The heating means is not particularly limited, and may be for instance a conventional means such as gas heating or induction-heater heating, i.e. heating using a high-frequency induction heating device.

The alloying process is followed by cooling. As described above, a structure composed mainly of tempered martensite and having a coefficient of variation of KAM of 0.66 or less is obtained as a result of the below-described cooling step (1A) or (1B), after the alloying process. The respective steps are explained next.

(1A) Step of, after alloying, performing cooling (primary cooling) at an average cooling rate of 10° C./sec or higher over a temperature region down to 300° C., and thereafter performing cooling (secondary cooling) at an average cooling rate of 5° C./sec or lower over a temperature region from 300° C. to 150° C.

The purpose of quenching over the above the temperature region, at an average cooling rate of 10° C./sec or higher (notated as primary cooling rate in the tables below) in the primary cooling step, is to inhibit generation of bainite. The primary cooling rate is preferably 15° C./sec or higher, more preferably 20° C./sec or higher. The upper limit of the primary cooling rate is not particularly limited from the viewpoint of bainite suppression, but is preferably about 100° C./sec or lower in terms for instance of equipment capacity.

Martensite can be generated, without generation of bainite, by setting a cooling stop temperature in the primary cooling step to 300° C.

The purpose of gradual cooling over the above the temperature region, at an average cooling rate of 5° C./sec or lower (notated as secondary cooling rate in the tables below) in the secondary cooling step, is to obtain auto-tempered martensite through auto-tempering of martensite generated in the above primary cooling step. The coefficient of variation of KAM as well becomes 0.66 or less as a result. The secondary cooling rate is preferably 4° C./sec or lower, more preferably 3° C./sec or lower. The lower limit of the secondary cooling rate is not particularly limited from the viewpoint of securing the desired auto-tempered martensite, but is preferably about 1° C./sec or higher in terms for instance of equipment capacity.

(1B) A step of, after alloying, performing cooling at an average cooling rate of 10° C./sec or higher over a temperature region down to 300° C.; and step of performing tempering so as to satisfy Expression (1) below.

9000≤(A+273)×{ log(B/3600)+20)}≤13500 Expression (1)

After alloying, there is firstly performed cooling at an average cooling rate of 10° C./sec or higher over a temperature region down to 300° C. This cooling step corresponds to the primary cooling in (1A) described above; the preferred average cooling rate may be referenced to the above step.

This is followed by cooling down to room temperature. With no need to perform predetermined secondary cooling as in (1A) described above, the cooling rate at this time is not particularly limited. That is because in (1B) there is no need to keep in mind the average cooling rate from 300° C. to room temperature, since the below-described tempering is carried out instead of the secondary cooling step (step of obtaining auto-tempered martensite through auto-tempering of the martensite generated in the primary cooling step) in (1A) above. Specifically, for instance, two-stage cooling may be carried out by controlling the average cooling rate from 300° C. to room temperature to be 5° C./sec or lower, as in (1A) above; alternatively, the average cooling rate may be set to be higher than 5° C./sec. In the latter case, cooling may be performed within a range of average cooling rate in the temperature region down to 300° C.; for instance, cooling can be performed down to room temperature at the same rate as the average cooling rate in the temperature region down to 300° C. Preferably, the cooling rate from 300° C. to room temperature is 1° C./sec or higher, with productivity in mind. The average cooling rate is more preferably 2° C./sec or higher, and yet more preferably 5° C./sec or higher. On the other hand, the average cooling rate is preferably 25° C./sec or lower, in terms for instance of ease of control of the steel sheet temperature and equipment capacity. The average cooling rate is more preferably 20° C./sec or lower, and yet more preferably 15° C./sec or lower.

Tempering is performed next so as to that satisfy Expression (1) above.

In Expression (1), it is necessary that a tempering parameter “(A+273)×{ log(B/3600)+20)”, which represents a balance between the tempering temperature A (° C.) and the tempering time B (seconds) being the keeping time at the tempering temperature A (° C.), satisfies the range of 9000 to 13500. By performing tempering under the conditions prescribed in Expression (1), martensite becomes tempered and strain in the base steel sheet becomes homogeneous; as a result, the coefficient of variation of KAM is lowered, and it becomes possible to increase YR. Results of studies by the inventors have revealed that the coefficient of variation of KAM can be brought to 0.66 or less and YR to 73.0% or higher by performing tempering so as to satisfy Expression (1).

Expression (1), which is an index that denotes the hardness after tempering, i.e. the degree of tempering, is known from experience, as disclosed in for instance “Courses of Contemporary Metallurgy; Materials Part 4; Iron and Steel Materials (published by The Japan Institute of Metals and Materials, pp. 50-51)”.

When the tempering parameter in Expression (1) is smaller than 9000, tempering is insufficient, the coefficient of variation of KAM increases, and YR decreases. Accordingly, the lower limit of the tempering parameter is set to be 9000 or greater. The lower limit of the tempering parameter is preferably set to be 9400 or greater, more preferably to 9800 or greater and yet more preferably to 10200 or greater. When the tempering parameter exceeds 13500, on the other hand, tensile strength may decrease, or alloying may proceed to an excessive degree. Accordingly, the upper limit of the tempering parameter is set to be 13500 or smaller. The upper limit of the tempering parameter is preferably set to be 13000 or smaller, more preferably 12500 or smaller and yet more preferably 12000 or smaller.

The tempering temperature A (° C.) and the tempering time B (seconds) in Expression (1) are not particularly limited, so long as they lie in ranges that satisfy Expression (1), but it is recommended that the tempering temperature A (° C.) and the tempering time B (seconds) be controlled as follows.

Firstly, the lower limit of the tempering temperature A is preferably set to be 100° C. or higher, with productivity in mind. More preferably, the lower limit is 150° C. or higher, yet more preferably 200° C. or higher. The upper limit of the tempering temperature A is preferably set to 500° C. or lower, for instance in terms of ease of control of the steel sheet temperature and equipment capacity. The upper limit is more preferably 450° C. or lower, and yet more preferably 400° C. or lower.

Moreover, the lower limit of the tempering time B is preferably set to be 5 seconds or longer, in terms of ease of control of the tempering time. The lower limit is more preferably 10 seconds or longer, and yet more preferably 20 seconds or longer. The upper limit of the tempering time B is preferably set to be 1000 seconds or shorter, with productivity in mind. The upper limit is more preferably 200 seconds or shorter, and yet more preferably 100 seconds or shorter.

The average heating rate in which the temperature is heated from room temperature to the tempering temperature A (° C.) is not particularly limited, but is preferably 2° C./sec or higher, more preferably 5° C./sec or higher, with productivity in mind. The upper limit of the average heating rate is not particularly limited, but is preferably 100° C./sec or lower, more preferably 20° C./sec or lower, for instance in terms of ease of control of the steel sheet temperature and equipment capacity.

The average cooling rate from the tempering temperature A (° C.) to room temperature is not particularly limited, but is preferably 2° C./sec or higher, more preferably 5° C./sec or higher, with productivity in mind. The upper limit of the above average cooling rate is not particularly limited, but is preferably 100° C./sec or lower, more preferably 20° C./sec or lower, for instance in terms of ease of control of the steel sheet temperature and equipment capacity.

[Second Production Method (with Temperature Keeping)]

The second production method according to the present invention comprises, in this order: a hot rolling step of coiling a hot-rolled steel sheet that satisfies the above steel components at a temperature of 500° C. or higher, to obtain as a result a hot-rolled steel sheet having an internal oxide layer formed therein; a step of keeping in a temperature region of 500° C. or higher for 80 minutes or more; a step of pickling-cold rolling such that there remain 4 μm or more of the average depth d of the internal oxide layer; a step of oxidizing at an air ratio in the range of 0.9 to 1.4, in an oxidation zone; a step of soaking within a range Ac₃ point to (Ac₃ point+100° C.), in a reduction zone; a step of, after soaking, performing cooling at an average cooling rate of 5° C./sec or higher over a range down to 600° C.; a low-temperature keeping step of setting to 20 seconds or less the keeping time in a temperature region of 480° C. or lower until immersion in a galvanizing bath; and a step for, after alloying, obtaining a structure composed mainly of tempered martensite and having a coefficient of variation of KAM of 0.66 or less. In the present invention, the step for, after alloying, obtaining a structure composed mainly of martensite and having a coefficient of variation of KAM of 0.66 or less, involves performing the above (1A) or (1B), as in the first production method described above. The second production method differs from the first production method described above only as regards two features, namely in that in the second production method the lower limit of the coiling temperature after hot rolling is set to be 500° C. or higher, and in that a temperature keeping step is provided after the hot-rolling step. Accordingly, only the above differences will be explained below. Steps identical to those of the first production method may be referenced to the first production method above.

The reason for providing the temperature keeping step is to enable prolonged keeping in a temperature region that allows for oxidation through temperature keeping, so as to expand the lower limit of the coiling temperature range within which there are obtained the desired internal oxide layer and soft layer. A further advantage herein is the increased homogeneity of the base steel sheet, resulting from a smaller temperature difference between the surface layer and the interior of the base steel sheet.

In the second production method, firstly the coiling temperature after hot rolling is controlled to 500° C. or higher. As explained in detail further on, the lower limit of the coiling temperature can be set herein to be lower than that of the first production method described above, i.e. 600° C. or higher, since in the second production method there is provided the subsequent temperature keeping step. A preferred coiling temperature is 540° C. or higher, and more preferably 570° C. or higher. The preferred upper limit in the coiling temperature is identical to that of the first production method described above, and is preferably set to be 750° C. or lower.

Next, the hot-rolled steel sheet thus obtained is kept in a temperature region of 500° C. or higher for 80 minutes or more. The desired internal oxide layer and soft layer can be obtained as a result. Preferably, the temperature of the hot-rolled steel sheet is kept by placing the latter in a thermally-insulated apparatus, in such a way so as to effectively bring out the effect derived from temperature keeping. The above apparatus used in the present invention is not particularly limited, so long as the device is made up of a thermally insulating material. Preferred materials that can be used as the thermally insulating material include ceramic fibers or the like.

The temperature must be kept in a region of 500° C. or higher for 80 minutes or more in order to elicit effectively the above effect. A preferred temperature is herein 540° C. or higher, and more preferably 560° C. or higher. The preferred time is 100 minutes or more, more preferably 120 minutes or more. The upper limits of temperature and time are preferably controlled to roughly 700° C. or lower and 500 minutes or less, for instance in terms of pickling properties and productivity.

The first and second production methods according to the present invention have been explained above.

The galvannealed steel sheet of the present invention obtained in accordance with the above production methods may be further subjected to various coating and coat-grounding treatments, for instance chemical conversion treatments such as a phosphate treatment, and organic coating treatments, for instance formation of an organic coating film such as a film laminate.

Coating materials that can be used in the above various coating schemes include known resins, for instance, epoxy resins, fluororesins, silicone acrylic resins, polyurethane resins, acrylic resins, polyester resins, phenol resins, alkyd resins, melamine resins and the like. Taking corrosion resistance into account, preferred among the foregoing are epoxy resins, fluororesins and silicon acrylic resins. A curing agent may be used together with the resins. The coating material may contain known additives, for instance coloring pigments, coupling agents, leveling agents, sensitizers, antioxidants, UV stabilizers, flame retardants and the like.

The form of the coating material in the present invention is not particularly limited, and there can be used coating materials in any form, for instance, solvent-based coating materials, aqueous coating materials, water-based coating materials, powder coating materials, electrodeposition coating materials and the like. Neither the coating method is particularly limited, and may involve dipping, roll coating, spraying, curtain flow coating, electrodeposition coating and the like. The thickness of the coating layer such as a galvannealed layer, an organic coating film, a chemical conversion coating, a coating film or the like may be set as appropriate in accordance with the intended application.

The galvannealed steel sheet of the present invention has ultra-high strength and boasts excellent formability in terms of bendability and hole expandability, as well as excellent delayed fracture resistance, and can therefore be used in automotive strong parts. For instance, the steel sheet can be used in crash parts such as front and rear side-members, crash boxes and the like; pillars such as center pillar reinforcements and the like; as well as car body components such as roof rail reinforcements, side sills, floor members, kick sections and the like.

The present invention has been explained in specific terms by way of working examples, but the invention is not limited by these examples, and can be carried out while including additional modifications within a scope conforming to the gist disclosed heretofore and hereinafter, all such modifications being encompassed within the technical scope of the invention.

The present application claims the right of priority based on Japanese Patent Application No. 2014-069351, filed on Mar. 28, 2014, and Japanese Patent Application No. 2015-012751, filed on Jan. 26, 2015. The entire contents the specifications of Japanese Patent Application No. 2014-069351, filed on Mar. 28, 2014, and Japanese Patent Application No. 2015-012751, filed on Jan. 26, 2015 are incorporated in the present application by reference.

### EXAMPLES

Slabs having the component composition given in Table 1, the balance being iron and inevitable impurities, were heated at 1250° C., and were hot-rolled down to 2.4 mm at a finish rolling temperature of 900° C., followed by coiling at the temperature given in Table 2.

Some of the examples, i.e. Nos. 24 to 26 and 35 to 38, were placed thereafter in a ceramic fiber heat-insulating apparatus, where the temperature was kept under the conditions given in Table 2. The keeping time at a temperature of 500° C. or higher was measured using a thermocouple attached to the outer periphery of the coil.

Each hot-rolled steel sheet thus obtained was then pickled under the conditions below, and was thereafter cold-rolled at a cold rolling ratio of 50%. The sheet thickness after cold rolling was 1.2 mm.

The pickling solution was 10% hydrochloric acid, the temperature was 82° C. and the pickling time as given in Table 2.

In a continuous galvanizing line, there were performed next annealing (oxidation, reduction) under the conditions given in Table 2, and cooling at a predetermined average cooling rate over a temperature region from the soaking temperature to about 600° C. The temperature of an oxidation furnace disposed in the continuous galvanizing line was controlled to 800° C., the hydrogen concentration in a reduction furnace was controlled to 20 vol %, with the balance being nitrogen and inevitable impurities, and the dew point was controlled to −45° C. The keeping time at the soaking temperature given in Table 2 was set to 50 seconds in all instances.

This was followed by keeping for a predetermined time in a temperature region of 480° C. or lower until immersion in a galvanizing bath; thereafter, each sheet was dipped in a galvanizing bath at 460° C., followed by heating at 500° C., and keeping of that temperature for 20 seconds, to perform an alloying process. After alloying, cooling was performed over a temperature region down to 300° C., at a primary average cooling rate given in Table 2; thereafter, cooling was performed over a temperature region from 300° C. to 150° C., at the secondary average cooling rate given in Table 2, and cooling was then performed at an average cooling rate of 5° C./sec over a temperature region from 150° C. to room temperature, to yield galvannealed steel sheets Nos. 1 to 38. In Nos. 27 to 38, cooling down to room temperature was followed by warming from room temperature to the tempering temperature, at an average heating rate of 5° C./sec; thereafter, tempering was carried out under the conditions given in Table 2, and cooling was performed from the tempering temperature to room temperature at an average cooling rate of 10° C./sec, to yield respective galvannealed steel sheets.

The galvannealed steel sheets thus obtained were evaluated for the below-described characteristics. As described below, the average depth of the internal oxide layer was measured not only in each galvannealed steel sheet, but was likewise measured, for reference, in the base steel sheet after pickling and cold rolling. The purpose of this is to ensure that the desired average depth of the internal oxide layer is obtained already in the cold-rolled steel sheet before annealing, through control of for instance the coiling temperature and pickling conditions after hot rolling.

(1) Measurement of the Average Depth d of the Internal Oxide Layer of Galvannealed Steel Sheets

Taking as W the sheet width of each galvannealed steel sheet, a test piece having a size of 50 mm×50 mm was sampled from an exposed W/4 portion, being a cross-section perpendicular to the direction of the sheet width W of the galvannealed steel sheet. Thereafter, the O amount, Fe amount and Zn amount from the galvannealed layer surface were analyzed and quantified by GD-OES (Glow Discharge-Optical Emission Spectroscopy). In further detail, the surface of the test piece was high-frequency sputtered within an Ar glow discharge region, using a GD-OES device of GD-PROFILER 2 GDA 750, by HORIBA Ltd. Next, the respective emission lines of the sputtered elements O, Fe and Zn in the Ar plasma were resolved continuously, to measure as a result the respective element content profiles in the depth direction of the base steel sheet. The sputtering conditions were as described below, and the measurement region was set to extend to a depth of 50 μm from the galvannealed layer surface.

(Sputtering Conditions)

Pulsed sputtering frequency: 50 Hz
Anode diameter (analysis surface area): 6 mm diameter
Discharge power: 30 W
Ar gas pressure: 2.5 hPa

The results of the analysis are illustrated in FIG. 2. As illustrated in FIG. 2, the interface of the galvannealed layer and the base steel sheet was set at the position from the galvannealed layer surface at which the Zn amount and the Fe amount were equal. The average value of the O amount at each measurement position in a depth in the range of 40 to 50 μm from the galvannealed layer surface was taken as the bulk O amount average value, and a range 0.02% higher than that (i.e. O amount≥(bulk O amount average value+0.02%)) was defined as the internal oxide layer. The maximum depth of that range was taken as the depth of the internal oxide layer. A similar test was performed using three test pieces, and the average of the foregoing was taken as the average depth d of the internal oxide layer.

(2) Measurement of the Internal Oxide Layer Depth after Pickling-Cold Rolling (Reference)

The average depth of the internal oxide layer was calculated in the same way as in (1), but using herein the base steel sheet after pickling-cold rolling.

(3) Measurement of the Average Depth D of the Soft Layer

A test piece having a size of 20 mm×20 mm was sampled from an exposed W/4 portion, being a cross-section perpendicular to the direction of the sheet width W of each galvannealed steel sheet. Thereafter, the test piece was embedded in resin, and Vickers hardness was measured from the interface of the galvannealed layer and the base steel sheet towards the interior of the base steel sheet at a sheet thickness t. In further detail, the hardness was measured at a load of 3 gf using a Vickers hardness tester. In detailed terms, measurements were performed at pitches of 5 μm inward in the sheet thickness, starting at a measurement position at a depth of 10 μm inward in the sheet thickness, from the interface of the galvannealed layer and the matrix, as illustrated in FIG. 3. The Vickers hardness was measured down to a depth of 100 μm. The spacing between measurement points (distance between x and x in FIG. 3) was set to be 15 μm or greater at the lowest. The Vickers hardness was measured by n=1 for each depth, to investigate the hardness distribution in the inward direction of the sheet thickness. The Vickers hardness at a portion t/4 of the base steel sheet was also measured (n=1) under a load of 1 kgf, using a Vickers hardness tester. A region having a Vickers hardness of 90% or less with respect to that of the portion t/4 of the base steel sheet was considered a soft layer, and the depth of the latter was calculated. The same process was carried out at 10 sites in one same test piece, and the average was taken as the average depth D of the soft layer.

(4) Method for Measuring Structure Fraction of the Galvannealed Steel Sheets

Herein, a W/4 portion, being a cross-section perpendicular to the direction of the sheet width W of the galvannealed steel sheet, was exposed and the cross-section was polished and then electropolished; thereafter, the cross-section was corroded with nital, and was observed by SEM (Scanning Electron Microscope). The observation position was set to a t/4 position, where t is the sheet thickness of the base steel sheet, the observation magnifications were set to 2000 times, and the observation region to 40 μm×40 μm. The metal structure micrographs captured by SEM were subjected to image analysis, to measure the respective area ratios of martensite, bainite and ferrite. In Table 2, α=ferrite, B is bainite and M is martensite (including tempered martensite and fresh martensite). In Table 2, the area fraction of the “other” structure was calculated by subtracting the area ratios of martensite, bainite and ferrite from 100 area %. The observations were carried out arbitrarily in three fields of view, and the average value of the foregoing was calculated.

(5) Measurement Method in a Tensile Test

Herein, JIS 13B tensile test pieces were sampled in such a manner that the direction perpendicular to the rolling direction of the galvannealed steel sheet and the longitudinal direction of the test pieces were parallel, and the tensile strength (TS) and yield stress (YS) in the C direction were measured according to JIS Z2241. The yield ratio YR (YS/TS) was calculated from TS and YS.

In the examples, those test pieces having a tensile strength TS of 1180 MPa or higher were rated as of high strength (acceptable). Those test pieces having YR of 73.0% or higher were rated as having excellent impact absorption properties (acceptable).

(6) Coefficient of Variation of KAM

Herein, KAM was worked out through measurement of a crystal orientation difference between adjacent measurement points, by EBSD. In further detail, a W/4 portion, being a cross-section perpendicular to the direction of the sheet width W of the galvannealed steel sheet, was exposed and the cross-section was polished; thereafter, there were measured local orientation differences, in measurement steps at a 0.1 μm spacing, in a 30 μm×30 μm measurement region at the t/4 position in the sheet thickness t of the base steel sheet. Measurement points having a CI (Confidence index) denoting the reliability of the measured orientation lower than 0.1 were deemed to lack reliability and were excluded from the analysis target. Then KAM was measured for a total of three measurement regions, and the mean value and standard deviation of KAM were calculated, to work out the coefficient of variation of KAM (=standard deviation/mean).

(7) Bending Work Test

Herein, 20 mm×70 mm test pieces were cut out of the galvannealed steel sheets in such a manner that the direction perpendicular to the rolling direction of the galvannealed steel sheets and the longitudinal direction of the test pieces were parallel, and a 90° V-bending test was carried so that a bending ridge line coincided with the longitudinal direction. The test was performed by modifying the bending radius R as appropriate, and there was worked out the minimum bending radius Rmin that allowed for bending work without cracks occurring in the test pieces.

Bendability was evaluated for each tensile strength TS, on the basis of Rmin/t, which is the quotient of Rmin divided by the sheet thickness t of the base steel sheet. The details are as follows. Bendability was not evaluated (marked as “-” in Table 3) for test pieces in which TS did not satisfy the acceptance criteria (being 1180 MPa or higher). Herein, Rmin/t<2.50 was deemed as acceptable when TS was 1180 MPa or higher.

(8) Delayed Fracture Resistance Test

Herein, a W/4 portion, being a cross-section perpendicular to the direction of the sheet width W of each galvannealed steel sheet, was exposed, and a 150 mm (W)×30 mm (L) test piece was cut out and was U-bent at a minimum bending radius; thereafter, the test piece was fastened with bolts, and the outer surface of the U-bent test piece was loaded under a tensile stress of 1000 MPa. To measure tensile stress, a strain gauge was affixed to the outside of the U-bent test piece, and strain was converted to tensile stress. Thereafter, the edges of the U-bent test piece were masked, and the test piece was electrochemically charged with hydrogen. Hydrogen charging was carried out herein through immersion in a mixed solution of 0.1M—H₂SO₄ (pH=3) and 0.01M—KSCN, under conditions of room temperature and constant current of 100 μA/mm².

In the results of the hydrogen charge test, instances with no cracking in 24 hours were rated as acceptable, i.e. of excellent delayed fracture resistance.

(9) Hole Expansion Test

A hole expansion test was carried out according to the Japan Iron and Steel Federation Standard JFS T 1001, to measure λ. In further detail, holes having a diameter of 10 mm were punched in the galvannealed steel sheet; thereafter a 60° conical punch was pressed into the hole, with the periphery of the latter in a restrained state, and the diameter of the hole at the crack initiation limit was measured. A limit hole expansion ratio λ (%) was worked out on the basis of the expression below. Instances where λ, was 25% or higher were rated as acceptable, i.e. of excellent hole expandability.

Limit hole expansion ratio λ(%)={(Df−D0)/D0}×100

In the expression, Df denotes the diameter (mm) of the hole at the crack initiation limit, and D0 denotes the diameter (mm) of the initial hole.

(10) Appearance of the Galvannealed Steel Sheets

The appearance of the galvannealed steel sheets was observed visually, and platability was evaluated on the basis of the occurrence or absence of unplated portions.

The results are summarized in Table 2 and Table 3.

TABLE 1

| | Steel | Components (mass %) | | | | | | | | | | | | | | | Ac₃ |
|---|---|---|---|---|---|---|---|---|---|---|---|---|---|---|---|---|---|
| No. | type | C | Si | Mn | P | S | Al | N | Cr | Mo | B | Ti | Nb | V | Cu | Ni | (° C.) |
| 1 | A | 0.11 | 1.13 | 2.63 | 0.009 | 0.003 | 0.045 | 0.0041 | | | | | | | | | 839 |
| 2 | B | 0.13 | 0.89 | 2.21 | 0.010 | 0.002 | 0.038 | 0.0036 | 0.35 | | | | | | | | 829 |
| 3 | C | 0.14 | 1.42 | 2.33 | 0.009 | 0.002 | 0.042 | 0.0042 | | 0.21 | | | | | | | 857 |
| 4 | D | 0.15 | 1.23 | 2.18 | 0.012 | 0.004 | 0.041 | 0.0046 | | | 0.0025 | | | | | | 846 |
| 5 | E | 0.09 | 1.65 | 2.75 | 0.010 | 0.002 | 0.034 | 0.0034 | | | | 0.07 | | | | | 889 |
| 6 | F | 0.09 | 1.64 | 2.72 | 0.011 | 0.002 | 0.036 | 0.0038 | | | | | 0.09 | | | | 863 |
| 7 | G | 0.10 | 1.62 | 2.77 | 0.011 | 0.002 | 0.042 | 0.0043 | | | | | | 0.10 | | | 870 |
| 8 | H | 0.13 | 1.26 | 2.56 | 0.009 | 0.002 | 0.037 | 0.0032 | | | | | | | 0.18 | | 834 |
| 9 | I | 0.12 | 1.35 | 2.54 | 0.012 | 0.003 | 0.040 | 0.0041 | | | | | | | | 0.17 | 831 |
| 10 | J | 0.11 | 1.06 | 2.40 | 0.010 | 0.002 | 0.042 | 0.0044 | 0.18 | | 0.0028 | 0.02 | | | | | 848 |
| 11 | M | 0.26 | 1.10 | 2.05 | 0.009 | 0.003 | 0.041 | 0.0039 | | | | | | | | | 817 |
| 12 | N | 0.15 | 0.35 | 2.45 | 0.011 | 0.002 | 0.041 | 0.0033 | | | | | | | | | 798 |
| 13 | O | 0.12 | 1.54 | 1.85 | 0.015 | 0.002 | 0.042 | 0.0042 | 0.20 | | 0.0023 | 0.04 | | | | | 894 |
| 14 | A | 0.11 | 1.13 | 2.63 | 0.009 | 0.003 | 0.045 | 0.0041 | | | | | | | | | 839 |
| 15 | A | 0.11 | 1.13 | 2.63 | 0.009 | 0.003 | 0.045 | 0.0041 | | | | | | | | | 839 |
| 16 | A | 0.11 | 1.13 | 2.63 | 0.009 | 0.003 | 0.045 | 0.0041 | | | | | | | | | 839 |
| 17 | A | 0.11 | 1.13 | 2.63 | 0.009 | 0.003 | 0.045 | 0.0041 | | | | | | | | | 839 |
| 18 | A | 0.11 | 1.13 | 2.63 | 0.009 | 0.003 | 0.045 | 0.0041 | | | | | | | | | 839 |
| 19 | A | 0.11 | 1.13 | 2.63 | 0.009 | 0.003 | 0.045 | 0.0041 | | | | | | | | | 839 |
| 20 | A | 0.11 | 1.13 | 2.63 | 0.009 | 0.003 | 0.045 | 0.0041 | | | | | | | | | 839 |
| 21 | A | 0.11 | 1.13 | 2.63 | 0.009 | 0.003 | 0.045 | 0.0041 | | | | | | | | | 839 |
| 22 | A | 0.11 | 1.13 | 2.63 | 0.009 | 0.003 | 0.045 | 0.0041 | | | | | | | | | 839 |
| 23 | A | 0.11 | 1.13 | 2.63 | 0.009 | 0.003 | 0.045 | 0.0041 | | | | | | | | | 839 |
| 24 | A | 0.11 | 1.13 | 2.63 | 0.009 | 0.003 | 0.045 | 0.0041 | | | | | | | | | 839 |
| 25 | A | 0.11 | 1.13 | 2.63 | 0.009 | 0.003 | 0.045 | 0.0041 | | | | | | | | | 839 |
| 26 | A | 0.11 | 1.13 | 2.63 | 0.009 | 0.003 | 0.045 | 0.0041 | | | | | | | | | 839 |
| 27 | P | 0.12 | 1.35 | 2.55 | 0.011 | 0.002 | 0.042 | 0.0037 | | | | | | | | | 848 |
| 28 | P | 0.12 | 1.35 | 2.55 | 0.011 | 0.002 | 0.042 | 0.0037 | | | | | | | | | 848 |
| 29 | P | 0.12 | 1.35 | 2.55 | 0.011 | 0.002 | 0.042 | 0.0037 | | | | | | | | | 848 |
| 30 | P | 0.12 | 1.35 | 2.55 | 0.011 | 0.002 | 0.042 | 0.0037 | | | | | | | | | 848 |
| 31 | P | 0.11 | 1.13 | 2.63 | 0.009 | 0.003 | 0.045 | 0.0041 | | | | | | | | | 839 |
| 32 | P | 0.11 | 1.13 | 2.63 | 0.009 | 0.003 | 0.045 | 0.0041 | | | | | | | | | 839 |
| 33 | P | 0.11 | 1.13 | 2.63 | 0.009 | 0.003 | 0.045 | 0.0041 | | | | | | | | | 839 |
| 34 | J | 0.11 | 1.06 | 2.4 | 0.01 | 0.002 | 0.042 | 0.0044 | 0.18 | | 0.0028 | 0.02 | | | | | 848 |
| 35 | P | 0.11 | 1.13 | 2.63 | 0.009 | 0.003 | 0.045 | 0.0041 | | | | | | | | | 839 |
| 36 | P | 0.11 | 1.13 | 2.63 | 0.009 | 0.003 | 0.045 | 0.0041 | | | | | | | | | 839 |
| 37 | P | 0.11 | 1.13 | 2.63 | 0.009 | 0.003 | 0.045 | 0.0041 | | | | | | | | | 839 |
| 38 | J | 0.11 | 1.06 | 2.4 | 0.01 | 0.002 | 0.042 | 0.0044 | 0.18 | | 0.0028 | 0.02 | | | | | 848 |

TABLE 2

| | | | | | | Aver- | | | | | | | | | | | | | |
|---|---|---|---|---|---|---|---|---|---|---|---|---|---|---|---|---|---|---|---|
| | | | | Keep- | | age | | | | | | | | | | | | | |
| | | | | ing | | depth | | | | Keep- | | | | | | | Aver- | | |
| | | | | time | | of | | | | ing | | | | | | | age | | |
| | | | | in a | | inter- | | | | time | | | | | | | depth | Aver- | |
| | | Coil- | | tem- | | nal | | | | in a | | | | | | | d of | age | |
| | | ing | | per- | | oxide | | | | tem- | After | | | | | | inter- | depth | |
| | | tem- | | ature | | layer | | | | per- | alloying | | | | | | nal | D of | |
| | | per- | | region | | after | Air | | Aver- | ature | Pri- | Secon- | | | | | oxide | soft | |
| | | ature | | of | | pick- | ratio | Soak- | age | region | mary | dary | | | | | layer | layer | |
| | | after | Tem- | 500° | | ling- | in | ing | cool- | of | cool- | cool- | Tempering | | | | after | after | |
| | | hot | per- | C. | Pick- | cold | oxida- | tem- | ing | 480° | ing | ing | | Tem- | | Temp- | galva- | galva- | |
| | | roll- | ature | or | ling | roll- | tion | per- | rate | C. or | rate | rate | | per- | | ering | nneal- | nneal- | |
| | Steel | ing | keep- | higher | time | ing | furn- | ature | (° C./ | below | (° C./ | (° C./ | Yes/ | ature | Time | para- | ing | ing | D/ |
| No. | type | (° C.) | ing | (min) | (sec) | (μm) | ace | (° C.) | sec) | (sec) | sec) | sec) | No | (° C.) | (sec) | meter | (μm) | (μm) | 2d |
| 1 | A | 660 | No | — | 45 | 12 | 1.1 | 900 | 10 | 10 | 25 | 2 | No | — | — | — | 11 | 24 | 1.09 |
| 2 | B | 660 | No | — | 45 | 10 | 1.1 | 900 | 10 | 10 | 25 | 2 | No | — | — | — | 11 | 27 | 1.23 |
| 3 | C | 660 | No | — | 45 | 12 | 1.1 | 900 | 10 | 10 | 25 | 2 | No | — | — | — | 12 | 25 | 1.04 |
| 4 | D | 660 | No | — | 45 | 10 | 1.1 | 900 | 10 | 10 | 25 | 2 | No | — | — | — | 11 | 23 | 1.05 |
| 5 | E | 660 | No | — | 45 | 11 | 1.1 | 900 | 10 | 10 | 25 | 2 | No | — | — | — | 12 | 34 | 1.42 |
| 6 | F | 660 | No | — | 45 | 10 | 1.1 | 900 | 10 | 10 | 25 | 2 | No | — | — | — | 11 | 29 | 1.32 |
| 7 | G | 660 | No | — | 45 | 11 | 1.1 | 900 | 10 | 10 | 25 | 2 | No | — | — | — | 12 | 26 | 1.08 |
| 8 | H | 660 | No | — | 45 | 12 | 1.1 | 900 | 10 | 10 | 25 | 2 | No | — | — | — | 13 | 27 | 1.04 |
| 9 | I | 660 | No | — | 45 | 11 | 1.1 | 900 | 10 | 10 | 25 | 2 | No | — | — | — | 12 | 28 | 1.17 |
| 10 | J | 660 | No | — | 45 | 11 | 1.1 | 900 | 10 | 10 | 25 | 2 | No | — | — | — | 12 | 25 | 1.04 |
| 11 | M | 660 | No | — | 45 | 13 | 1.1 | 900 | 10 | 10 | 25 | 2 | No | — | — | — | 14 | 36 | 1.29 |
| 12 | N | 660 | No | — | 45 | 3 | 1.1 | 900 | 10 | 10 | 25 | 2 | No | — | — | — | 3 | 21 | 3.50 |
| 13 | O | 660 | No | — | 45 | 13 | 1.1 | 900 | 10 | 10 | 25 | 2 | No | — | — | — | 13 | 29 | 1.12 |
| 14 | A | 570 | No | — | 45 | 2 | 1.1 | 900 | 10 | 10 | 25 | 2 | No | — | — | — | 3 | 15 | 2.50 |
| 15 | A | 620 | No | — | 45 | 11 | 1.1 | 900 | 10 | 10 | 25 | 2 | No | — | — | — | 11 | 23 | 1.05 |
| 16 | A | 660 | No | — | 45 | 11 | 1.0 | 900 | 10 | 10 | 25 | 2 | No | — | — | — | 11 | 20 | 0.91 |
| 17 | A | 660 | No | — | 45 | 12 | 0.8 | 900 | 10 | 10 | 25 | 2 | No | — | — | — | 12 | 12 | 0.50 |
| 18 | A | 660 | No | — | 45 | 12 | 1.1 | 825 | 10 | 10 | 25 | 2 | No | — | — | — | 11 | 24 | 1.09 |
| 19 | A | 660 | No | — | 45 | 12 | 1.1 | 900 | 2 | 10 | 25 | 2 | No | — | — | — | 11 | 25 | 1.14 |
| 20 | A | 660 | No | — | 45 | 12 | 1.1 | 900 | 10 | 30 | 25 | 2 | No | — | — | — | 11 | 25 | 1.14 |
| 21 | A | 660 | No | — | 45 | 12 | 1.1 | 900 | 10 | 15 | 25 | 2 | No | — | — | — | 11 | 25 | 1.14 |
| 22 | A | 660 | No | — | 45 | 12 | 1.1 | 900 | 10 | 10 | 5 | 2 | No | — | — | — | 11 | 25 | 1.14 |
| 23 | A | 660 | No | — | 45 | 12 | 1.1 | 900 | 10 | 10 | 25 | 10 | No | — | — | — | 11 | 25 | 1.14 |
| 24 | A | 470 | Yes | 180 | 45 | 2 | 1.1 | 900 | 10 | 10 | 25 | 2 | No | — | — | — | 2 | 17 | 4.25 |
| 25 | A | 570 | Yes | 180 | 45 | 12 | 1.1 | 900 | 10 | 10 | 25 | 2 | No | — | — | — | 12 | 32 | 1.33 |
| 26 | A | 570 | Yes | 60 | 45 | 3 | 1.1 | 900 | 10 | 10 | 25 | 2 | No | — | — | — | 3 | 18 | 3.00 |
| 27 | P | 660 | No | — | 45 | 11 | 1.1 | 900 | 10 | 10 | 25 | 10 | Yes | 150 | 40 | 7633 | 11 | 25 | 1.14 |
| 28 | P | 660 | No | — | 45 | 11 | 1.1 | 900 | 10 | 10 | 25 | 10 | Yes | 250 | 5 | 8966 | 11 | 25 | 1.14 |
| 29 | P | 660 | No | — | 45 | 11 | 1.1 | 900 | 10 | 10 | 25 | 10 | Yes | 250 | 40 | 9438 | 11 | 25 | 1.14 |
| 30 | P | 660 | No | — | 45 | 11 | 1.1 | 900 | 10 | 10 | 25 | 10 | Yes | 250 | 200 | 9803 | 11 | 26 | 1.18 |
| 31 | P | 660 | No | — | 45 | 11 | 1.1 | 900 | 10 | 10 | 25 | 10 | Yes | 300 | 40 | 10340 | 11 | 26 | 1.18 |
| 32 | P | 660 | No | — | 45 | 12 | 1.1 | 900 | 10 | 10 | 25 | 10 | Yes | 350 | 40 | 11243 | 12 | 26 | 1.08 |
| 33 | P | 660 | No | — | 45 | 12 | 1.1 | 900 | 10 | 10 | 25 | 10 | Yes | 500 | 40 | 13949 | 12 | 27 | 1.13 |
| 34 | J | 660 | No | — | 45 | 11 | 1.1 | 900 | 10 | 10 | 25 | 10 | Yes | 300 | 40 | 10340 | 12 | 27 | 1.13 |
| 35 | P | 570 | Yes | 180 | 45 | 13 | 1.1 | 900 | 10 | 10 | 25 | 10 | Yes | 300 | 40 | 10340 | 13 | 28 | 1.08 |
| 36 | P | 570 | Yes | 180 | 45 | 13 | 1.1 | 900 | 10 | 10 | 25 | 10 | Yes | 250 | 5 | 8966 | 13 | 28 | 1.08 |
| 37 | P | 570 | Yes | 180 | 45 | 13 | 1.1 | 900 | 10 | 10 | 25 | 10 | Yes | 500 | 40 | 13949 | 13 | 28 | 1.08 |
| 38 | J | 570 | Yes | 180 | 45 | 13 | 1.1 | 900 | 10 | 10 | 25 | 10 | Yes | 300 | 40 | 10340 | 13 | 29 | 1.12 |

TABLE 3

| | | | | | | KAM | | | | | | | | |
|---|---|---|---|---|---|---|---|---|---|---|---|---|---|---|
| | | Hard layer structure | | | | Coefficient | | | | | Bendability | | Delayed | |
| | Steel | (area %) | | | | of | YS | TS | YR | λ | Rmin/ | | fracture | Unplated |
| No. | type | α | B | M | Other | variation | (MPa) | (MPa) | (%) | (%) | t | Evaluation | resistance | portions |
| 1 | A | 0 | 5 | 94 | 1 | 0.653 | 911 | 1243 | 73.3 | 43 | 1.7 | Acceptable | Acceptable | No |
| 2 | B | 0 | 4 | 96 | 0 | 0.634 | 932 | 1254 | 74.3 | 42 | 1.7 | Acceptable | Acceptable | No |
| 3 | C | 0 | 3 | 96 | 1 | 0.654 | 935 | 1277 | 73.2 | 36 | 1.7 | Acceptable | Acceptable | No |
| 4 | D | 0 | 6 | 94 | 0 | 0.650 | 914 | 1244 | 73.5 | 35 | 1.7 | Acceptable | Acceptable | No |
| 5 | E | 1 | 3 | 96 | 0 | 0.630 | 944 | 1269 | 74.4 | 48 | 1.7 | Acceptable | Acceptable | No |
| 6 | F | 0 | 4 | 95 | 1 | 0.628 | 938 | 1244 | 75.4 | 49 | 1.7 | Acceptable | Acceptable | No |
| 7 | G | 0 | 5 | 94 | 1 | 0.632 | 964 | 1295 | 74.4 | 43 | 1.7 | Acceptable | Acceptable | No |
| 8 | H | 0 | 2 | 98 | 0 | 0.631 | 952 | 1278 | 74.5 | 47 | 1.7 | Acceptable | Acceptable | No |
| 9 | I | 1 | 3 | 95 | 1 | 0.643 | 933 | 1267 | 73.6 | 45 | 1.7 | Acceptable | Acceptable | No |
| 10 | J | 0 | 6 | 93 | 1 | 0.632 | 898 | 1210 | 74.2 | 43 | 1.7 | Acceptable | Acceptable | No |
| 11 | M | 0 | 3 | 97 | 0 | 0.678 | 1075 | 1614 | 66.6 | 22 | 2.9 | Reject | Reject | No |
| 12 | N | 0 | 7 | 93 | 0 | 0.654 | 904 | 1232 | 73.4 | 36 | 2.5 | Reject | Reject | No |
| 13 | O | 6 | 14 | 79 | 1 | 0.697 | 764 | 1138 | 67.1 | 28 | 1.7 | — | Acceptable | No |
| 14 | A | 0 | 4 | 95 | 1 | 0.649 | 915 | 1240 | 73.8 | 44 | 2.5 | Reject | Reject | Yes |
| 15 | A | 0 | 3 | 96 | 1 | 0.650 | 912 | 1241 | 73.5 | 44 | 1.7 | Acceptable | Acceptable | No |
| 16 | A | 0 | 3 | 96 | 1 | 0.655 | 921 | 1250 | 73.7 | 40 | 2.1 | Acceptable | Acceptable | No |
| 17 | A | 0 | 5 | 94 | 1 | 0.654 | 912 | 1241 | 73.5 | 38 | 2.5 | Reject | Reject | Yes |
| 18 | A | 14 | 2 | 83 | 1 | 0.712 | 732 | 1185 | 61.8 | 28 | 2.9 | Reject | Reject | Yes |
| 19 | A | 9 | 6 | 85 | 0 | 0.698 | 780 | 1198 | 65.1 | 34 | 2.5 | Reject | Reject | No |
| 20 | A | 0 | 25 | 74 | 1 | 0.678 | 823 | 1188 | 69.3 | 45 | 1.7 | Acceptable | Acceptable | No |
| 21 | A | 0 | 9 | 90 | 1 | 0.658 | 900 | 1231 | 73.1 | 43 | 1.7 | Acceptable | Acceptable | No |
| 22 | A | 0 | 33 | 66 | 1 | 0.676 | 821 | 1185 | 69.3 | 41 | 1.7 | Acceptable | Acceptable | No |
| 23 | A | 0 | 4 | 95 | 1 | 0.666 | 875 | 1254 | 69.8 | 45 | 1.7 | Acceptable | Acceptable | No |
| 24 | A | 0 | 6 | 94 | 0 | 0.651 | 916 | 1238 | 74.0 | 46 | 2.5 | Reject | Reject | Yes |
| 25 | A | 0 | 6 | 93 | 1 | 0.647 | 904 | 1235 | 73.2 | 41 | 1.3 | Acceptable | Acceptable | No |
| 26 | A | 0 | 6 | 93 | 1 | 0.652 | 911 | 1238 | 73.6 | 40 | 2.5 | Reject | Reject | Yes |
| 27 | P | 0 | 4 | 96 | 0 | 0.672 | 865 | 1248 | 69.3 | 41 | 1.7 | Acceptable | Acceptable | No |
| 28 | P | 0 | 4 | 96 | 0 | 0.665 | 871 | 1247 | 69.8 | 42 | 1.7 | Acceptable | Acceptable | No |
| 29 | P | 0 | 3 | 97 | 0 | 0.652 | 925 | 1245 | 74.3 | 47 | 1.3 | Acceptable | Acceptable | No |
| 30 | P | 0 | 4 | 96 | 0 | 0.632 | 945 | 1239 | 76.3 | 47 | 1.3 | Acceptable | Acceptable | No |
| 31 | P | 0 | 4 | 95 | 1 | 0.615 | 955 | 1241 | 77.0 | 50 | 1.3 | Acceptable | Acceptable | No |
| 32 | P | 0 | 3 | 96 | 1 | 0.605 | 986 | 1242 | 79.4 | 54 | 1.3 | Acceptable | Acceptable | No |
| 33 | P | 0 | 4 | 96 | 0 | 0.580 | 911 | 1132 | 80.5 | 63 | 0.8 | — | Acceptable | No |
| 34 | J | 0 | 2 | 97 | 1 | 0.608 | 935 | 1209 | 77.3 | 45 | 0.8 | Acceptable | Acceptable | No |
| 35 | P | 0 | 5 | 95 | 0 | 0.615 | 945 | 1238 | 76.3 | 40 | 1.3 | Acceptable | Acceptable | No |
| 36 | P | 0 | 5 | 95 | 0 | 0.669 | 845 | 1237 | 68.3 | 40 | 1.3 | Acceptable | Acceptable | No |
| 37 | P | 0 | 5 | 95 | 0 | 0.581 | 889 | 1122 | 79.2 | 58 | 0.8 | — | Acceptable | No |
| 38 | J | 0 | 3 | 97 | 0 | 0.618 | 929 | 1201 | 77.4 | 48 | 0.8 | Acceptable | Acceptable | No |

The following observations arise from the tables.

Firstly, examples Nos. 1 to 10, 15, 16, 21, 25, 29 to 32, 34, 35 and 38 satisfied the requirements of the present invention, and all exhibited good strength, formability (bendability and hole expandability (λ)), delayed fracture resistance, impact absorption properties and platability. In particular, No. 1 (D/2d=1.09) in which the average depth d of the internal oxide layer and average depth D of the soft layer satisfied the relationship D>2d (i.e. value of “D/2d” greater than 1 in Table 2), exhibited better bendability than No. 16 (D/2d=0.91), which did not satisfy the above relationship. Further, λ as well was greater.

In No. 11, being an example with a large amount of C, the coefficient of variation of KAM was high and YR was low. Further bendability, λ and delayed fracture resistance were low.

In No. 12, being an example where the amount of Si was small and the soaking temperature high, the internal oxide layer failed to be generated sufficiently, and bendability and delayed fracture resistance were low.

In No. 13, being an example where the amount of Mn was small, hardenability was poor, and ferrite and bainite were generated excessively. As a result, the coefficient of variation of KAM was high, and both TS and YR were low.

In No. 14, being an example in which the coiling temperature during hot rolling was low, the average depth of the internal oxide layer after pickling-cold rolling was shallow, and accordingly the average depth d of the internal oxide layer and the average depth D of the soft layer after galvannealing were shallow. As a result, bendability, delayed fracture resistance and platability were low.

In No. 17, the air ratio in the oxidation furnace was low, the iron oxide film was not generated sufficiently, and platability was low. Further, the average depth D of the soft layer was shallow. As a result, bendability and delayed fracture resistance as well were low.

In No. 18, being an example where the soaking temperature was low, there occurred biphasic region annealing and excessive generation of ferrite. As a result, the coefficient of variation of KAM was high, and YR was low. Further, bendability, delayed fracture resistance and platability as well were low.

In No. 19, being an example with a low average cooling rate after soaking, ferrite was generated excessively during cooling. As a result, the coefficient of variation of KAM was high, and YR was low. Further bendability, and delayed fracture resistance as well were low.

In No. 20, being an example of long keeping time from 480° C. until plating, bainite was generated excessively. As a result, the coefficient of variation of KAM was high, and YR was low.

In No. 22, being an example of low primary cooling rate after alloying, bainite was generated excessively. As a result, the coefficient of variation of KAM was high, and YR was low.

In No. 23, being an example of high secondary cooling rate after alloying, the coefficient of variation of KAM was high. As a result, YR was low.

In No. 24, being an example in which the coiling temperature during hot rolling was low, the average depth of the internal oxide layer after pickling-cold rolling was shallow, and accordingly the average depth d of the internal oxide layer and the average depth D of the soft layer after galvannealing were shallow. As a result, bendability, delayed fracture resistance and platability were low.

In No. 26, being an example of insufficient temperature keeping time, the average depth of the internal oxide layer after pickling-cold rolling was shallow, and accordingly the average depth d of the internal oxide layer and the average depth D of the soft layer after galvannealing were shallow. As a result, bendability, delayed fracture resistance and platability were low.

In No. 27, being an example of low tempering parameter, tempering was insufficient, the coefficient of variation of KAM was high, and YR was low.

In No. 28, being an example of low tempering parameter, tempering was insufficient, the coefficient of variation of KAM was high, and YR was low.

In No. 33, being an example of high tempering parameter, tempering was excessive, and TS was low.

In No. 36, being an example of low tempering parameter, tempering was insufficient, the coefficient of variation of KAM was high, and YR was low.

In No. 37, being an example of high tempering parameter, tempering was excessive, and TS was low.

### REFERENCE SIGNS LIST

1 galvannealed layer
2 base steel sheet
3 internal oxide layer
4 soft layer
5 hard layer

1: A high-strength galvannealed steel sheet, which has a galvannealed layer on the surface of a base steel sheet, wherein
the base steel sheet contains, in mass %,
C: 0.05 to 0.25%;
Si: 0.5 to 2.5%;
Mn: 2.0 to 4%;
P: more than 0% to 0.1% or less;
S: more than 0% to 0.05% or less;
Al: 0.01 to 0.1%;
N: more than 0% to 0.01% or less; and
iron and inevitable impurities.

2-12. (canceled)

13: The high-strength galvannealed steel sheet according to claim 1, which sequentially has, from an interface of the base steel sheet and the galvannealed layer, towards the base steel sheet:
an internal oxide layer comprising at least one oxide selected from the group consisting of Si and Mn;
a soft layer comprising the internal oxide layer and satisfying a Vickers hardness of 90% or less of a Vickers hardness at a portion t/4 of the base steel sheet, when t is a sheet thickness of the base steel sheet; and
a hard layer made up of a structure mainly comprising martensite,
wherein the high-strength steel sheet satisfies:
an average depth D of the soft layer is 20 μm or greater; and
an average depth d of the internal oxide layer is 4 μm or greater and smaller than the D; and
a coefficient of variation of KAM (Kernel Average Misorientation) of the base steel sheet at the portion t/4 is 0.66 or less, a tensile strength being 1180 MPa or higher and a yield ratio YR being 73.0% or higher.

14: The high-strength galvannealed steel sheet according to claim 13, wherein the base steel sheet further comprises, in mass %, at least one of (a) to (c) below:
(a) at least one element selected from the group consisting of
Cr: more than 0% to 1% or less,
Mo: more than 0% to 1% or less and
B: more than 0% to 0.01% or less;
(b) at least one element selected from the group consisting of
Ti: more than 0% to 0.2% or less,
Nb: more than 0% to 0.2% or less and
V: more than 0% to 0.2% or less; and
(c) at least one element selected from the group consisting of
Cu: more than 0% to 1% or less and
Ni: more than 0% to 1% or less.

15: The high-strength galvannealed steel sheet according to claim 13, wherein the average depth d of the internal oxide layer and the average depth D of the soft layer satisfy the relationship D>2d.

16: The high-strength galvannealed steel sheet according to claim 14, wherein the average depth d of the internal oxide layer and the average depth D of the soft layer satisfy the relationship D>2d.

17: The high-strength galvannealed steel sheet according to claim 13, wherein the structure of the hard layer is
ferrite: 0 area % to 5 area %, and
bainite: 0 area % to 10 area %,
with respect to the entire structure.

18: The high-strength galvannealed steel sheet according to claim 14, wherein the structure of the hard layer is
ferrite: 0 area % to 5 area %, and
bainite: 0 area % to 10 area %,
with respect to the entire structure.

19: The high-strength galvannealed steel sheet according to claim 15, wherein the structure of the hard layer is
ferrite: 0 area % to 5 area %, and
bainite: 0 area % to 10 area %,
with respect to the entire structure.

20: The high-strength galvannealed steel sheet according to claim 16, wherein the structure of the hard layer is
ferrite: 0 area % to 5 area %, and
bainite: 0 area % to 10 area %,
with respect to the entire structure.

21: A method for producing the high-strength galvannealed steel sheet according to claim 13, the method comprising, in order:
coiling, at a temperature of 600° C. or higher, a steel sheet satisfying steel components of the base steel sheet;
pickling-cold rolling such that there remain 4 μm or more of the average depth d of the internal oxide layer;
oxidizing at an air ratio in a range of 0.9 to 1.4 in an oxidation zone;
soaking within a range Ac₃ point to (Ac₃ point+100° C.), in a reduction zone;
after the soaking, performing cooling at an average cooling rate of 5° C./sec or higher over a range down to 600° C.;
setting to 20 seconds or less a keeping time in a temperature region of 480° C. or lower until immersion in a galvanizing bath;
after alloying, cooling at an average cooling rate of 10° C./sec or higher over a temperature region down to 300° C., and thereafter, cooling at an average cooling rate of 5° C./sec or lower over a temperature region from 300° C. to 150° C.

22: A method for producing the high-strength galvannealed steel sheet according to claim 13, the method comprising, in order:
coiling, at a temperature of 600° C. or higher, a steel sheet satisfying steel components of the base steel sheet;
pickling-cold rolling such that there remain 4 μm or more of the average depth d of the internal oxide layer;
oxidizing at an air ratio in a range of 0.9 to 1.4, in an oxidation zone;
soaking within a range Ac₃ point to (Ac₃ point+100° C.), in a reduction zone;
after the soaking, performing cooling at an average cooling rate of 5° C./sec or higher over a range down to 600° C.;
setting to 20 seconds or less a keeping time in a temperature region of 480° C. or lower until immersion in a galvanizing bath;
after alloying, performing cooling at an average cooling rate of 10° C./sec or higher over a temperature region down to 300° C.; and
performing tempering in such a manner that Expression (1) is satisfied:
9000≤(A+273)×{ log(B/3600)+20)}≤13500 Expression (1)
wherein, A denotes tempering temperature (° C.), and B denotes tempering time (seconds).

23: A method for producing the high-strength galvannealed steel sheet according to claim 13, the method comprising, in order:
coiling, at a temperature of 500° C. or higher, a steel sheet satisfying the steel components of the base steel sheet;
keeping in a temperature region of 500° C. or higher for 80 minutes or more;
pickling-cold rolling such that there remain 4 μm or more of the average depth d of the internal oxide layer;
oxidizing at an air ratio in the range of 0.9 to 1.4, in an oxidation zone;
soaking within a range Ac₃ point to (Ac₃ point+100° C.), in a reduction zone;
after the soaking, performing cooling at an average cooling rate of 5° C./sec or higher over a range down to 600° C.;
setting to 20 seconds or less a keeping time in a temperature region of 480° C. or lower until immersion in a galvanizing bath;
after alloying, cooling at an average cooling rate of 10° C./sec or higher over a temperature region down to 300° C., and thereafter, cooling at an average cooling rate of 5° C./sec or lower over a temperature region from 300° C. to 150° C.

24: A method for producing the high-strength galvannealed steel sheet according to claim 13, the method comprising, in order:
coiling, at a temperature of 500° C. or higher, a steel sheet satisfying steel components of the base steel sheet;
keeping in a temperature region of 500° C. or higher for 80 minutes or more;
pickling-cold rolling such that there remain 4 μm or more of the average depth d of the internal oxide layer;
oxidizing at an air ratio in a range of 0.9 to 1.4, in an oxidation zone;
soaking within a range Ac₃ point to (Ac₃ point+100° C.), in a reduction zone;
after the soaking, performing cooling at an average cooling rate of 5° C./sec or higher over a range down to 600° C.;
setting to 20 seconds or less a keeping time in a temperature region of 480° C. or lower until immersion in a galvanizing bath;
after alloying, performing cooling at an average cooling rate of 10° C./sec or higher over a temperature region down to 300° C.; and
performing tempering in such a manner that Expression (1) is satisfied:
9000≤(A+273)×{ log(B/3600)+20)}≤13500 Expression (1)
wherein A denotes tempering temperature (° C.), and B denotes tempering time (seconds).
